(19) United States
(12) Patent Application Publication
(10) Pub. No.: US 2024/0389587 A1
(43) Pub. Date: Nov. 28, 2024

(54) COMPOSITIONS AND METHODS FOR CONTROLLING PHYTOPATHOGENIC INFECTIONS

(71) Applicants: INSTITUT NATIONAL DE RECHERCHE POUR L'AGRICULTURE, L'ALIMENTATION ET L'ENVIRONNEMENT (INRAE), Paris (FR); AGROCAMPUS OUEST (Institut national supérieur des sciences agronomiques, agro-alimentaires,, Rennes (FR); UNIVERSITÉ D'ANGERS, Angers (FR)

(72) Inventors: Nelly BATAILLÉ-SIMONEAU, St Clément de la Place (FR); Thomas CHARPENTIER, Angers (FR); Thomas GUILLEMETTE, Avrillé (FR); Anne-Marie LE RAY, Angers (FR); Pascal RICHOMME-PENIGUEL, Angers (FR); Philippe SIMONEAU, St Clément de la Place (FR); Guillaume VIAULT, Montreuil-Juigné (FR)

(73) Assignees: INSTITUT NATIONAL DE RECHERCHE POUR L'AGRICULTURE, L'ALIMENTATION ET L'ENVIRONNEMENT (INRAE), Paris (FR); AGROCAMPUS OUEST (Institut national supérieur des sciences agronomiques, agro-alimentaires,, Rennes (FR); UNIVERSITÉ D'ANGERS, Angers (FR)

(21) Appl. No.: 18/714,804

(22) PCT Filed: Nov. 30, 2022
(86) PCT No.: PCT/EP2022/083931

§ 371 Date: May 30, 2024

(30) Foreign Application Priority Data
Nov. 30, 2021 (EP) 21306671.5

(51) Int. Cl. A01N 43/16; A01N 65/08; A01P 3/00

(52) U.S. Cl. CPC A01N 43/16; A01N 65/08; A01P 3/00

(57) ABSTRACT

A phytopharmaceutical method for treating a plant organ affected by a phytopathogenic fungal strain. The method includes the steps of applying on the plant organ a composition including at least one xanthone UPR (Unfolded Protein Response) inhibitor, preferably, an IRE-1 (Inositol-Requiring Enzyme 1) inhibitor, in a sub-effective amount. Also, a phytopharmaceutical composition including at least one UPR (Unfolded Protein Response) inhibitor in a sub-effective amount.

### FIELD OF INVENTION

The present invention relates to a composition and a method aiming at preventing, controlling and/or treating plant organ infections by a phytopathogenic fungal strain.

### BACKGROUND OF INVENTION

Phytopathogenic fungi may affect a variety of plant organs, such as leaves, stems, fruits and seeds. Infected plant fruits are usually unfitted for sale, and an infection of leaves or seeds may alter plant development or germination, causing significant reduction of productivity. Therefore, fungal infections may result in substantial economic losses. The control of fungal infections of crops is thus a major economic issue.

Plant diseases result in an annual estimated loss of 10-15% of the world's major crops, with direct economic losses of up to hundreds of billions of dollars. Among the plant diseases, about 70 to about 80% are caused by pathogenic fungi (Peng et al. Front Microbiol. 2021; 12: 670135).

In order to prevent the occurrence of such crop diseases, farmers have to use many synthetic chemical pesticides. The extensive use of these pesticides has resulted in a series of environmental and ecological problems, such as for example soil compaction, and water pollution, which seriously affect the sustainable development of agriculture (Peng et al. Front Microbiol. 2021; 12:670135). Therefore, the conventional chemical fungicides commonly used to protect crops against fungal infection present the drawback to be highly pollutant for the environment, especially for soil and water supply. Moreover, these products may be toxic for humans.

There is thus a need for supplying new environment-respectful fungicidal compositions and methods in order to enrich the agricultural weaponry against phytopathogenic fungal strains.

The international application WO2014012766 discloses the use of fungal physiological pathway inhibitors such as Serine/Threonine Protein Kinase C inhibitors in the prevention and/or treatment of phytopathogenic fungal infections. However, in recent years, fungal diseases of crops have become increasingly serious as they have severely affected crop yield and quality, and they have become an important bottleneck for the development of sustainable agriculture.

However, WO2014012766 does not disclose the use of xanthones acting on the Unfolded Protein Response (UPR) pathway. The inventors surprisingly found that specific xanthone natural products as hereinafter described may exert an antifungal effect by acting on the UPR pathway once applied on a plant organ. Even more surprisingly, the antifungal effect is presented in planta when the composition according to the invention is applied in a sub-effective amount in vitro.

### SUMMARY

According to a first aspect, the invention relates to a method for preventing, controlling or treating a fungal infection by a phytopathogenic fungal strain on a plant organ, said method comprising the steps of applying on the plant organ a composition comprising at least one UPR (Unfolded Protein Response) inhibitor, preferably an IRE-1 (Inositol-Requiring Enzyme 1) inhibitor, in an in vitro sub-effective concentration being a concentration equal or inferior to a non-fungicidal concentration C1 of said inhibitor against the phytopathogenic fungal strain:
wherein the non-fungicidal concentration C1 is determined by comparing the growth of the phytopathogenic fungal strain cultures in contact with increasing concentrations of said at least one UPR inhibitor, with the growth of a control culture of the phytopathogenic fungal strain, in the absence of said at least one UPR inhibitor; the last concentration of the increasing concentrations of the at least one UPR inhibitor resulting in the same fungal culture growth as the control culture being retained as the non-fungicidal concentration C1 of said at least one UPR inhibitor; wherein the at least one UPR inhibitor is at least one xanthone of formula I

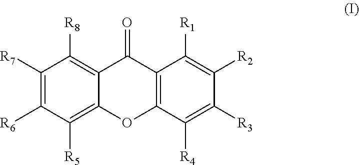

wherein
R2=R8: prenyl, R1=R3=R6=R7: OH, and R4=R5: H (γ-mangostin);
R1=R3=R5: OH, R2=R6=R7=R8: H, and R4: prenyl (1,3,5 trihydroxy-4-prenylxanthone);
R1=R3=R5: OH, R4=R6=R7=R8: H, and R2: prenyl (1,3,5 trihydroxy-2-prenylxanthone);
R1=R5=R6: OH, R2=R3=R4-R8: H, and R7: prenyl;
R8: geranyl, R1=R3=R6=R7: OH, and R4=R5: H (demethylrubraxanthone),
R1=R3=R4=R5: OH, R6=R7=R8: H, and R2: prenyl, wherein the R2 and R3 moieties form a 2,3,3-trimethyltetrahydrofuran ring
wherein the compound of formula (I) inhibits the UPR cellular development and environmental adaptation in the phytopathogenic fungal strain, once they have been exposed to the plant defense molecules expressed by the plant organ.

In one embodiment, the at least one UPR inhibitor is selected from the group consisting of γ-mangostin, 1,3,5 trihydroxy-4-prenylxanthone, 1,3,5 trihydroxy-2-prenylxanthone and a mixture thereof, preferably the at least one UPR inhibitor is γ-mangostin.

The at least one UPR inhibitor of the invention can be comprised in a Garcinia mangostana leaf, bark or pericarp extract, preferably comprised in a Garcinia mangostana pericarp extract.

Typically, the plant organ to be treated by the present method is a plant organ of the Brassicacae, Apiaceae, Vitaceae, Rosaceae, Solanaceae, Fabaceae, Poaceae, Musaceae, Alliaceae, Rutaceae and Sterculiaceae families, preferably the plant organ is plant organ of the plants selected from the list consisting of plants of the Brassicacae family, plants of the Apiaceae family, plants of the Vitaceae family, plants of the Rosaceae family and plants of the Poaceae family.

In some embodiments, the plant organ is a plant organ of the plants selected from the group consisting of Brassica oleracea, Daucus carota subsp. Sativus; Vitis vinifera; Malus domestica, Pyrus comunis, Prunus spp., in particular plums, cherries, peaches, nectarines, apricots, and almonds, and Triticum spp., preferably selected from the list consisting of the plants Brassica oleracea, Vitis vinifera; Malus domestica, and Triticum spp.

In some embodiments, the fungal infection to be prevented, controlled or treated is an infection by at least one phytopathogenic fungus selected from the group consisting of fungi of the order of Erysiphales further selected from the genera Uncinula, Erysiphe, Sphaerotheca; fungi of the order of Dothideales further selected from the genus Venturia); fungi of the order of Helotiales further selected from the genera Sclerotinia, Monilia/Monilinia, Botrytis/Botryotinia; fungi of the family Pleosporaceae, preferably further selected from the genus Alternaria; fungi of the order Mycosphaerellaceae further selected from the families Sclerotinia, Mycosphaerella and Zymoseptoria.

In some embodiments, the fungal infection is an infection by at least one phytopathogenic fungus selected from the group consisting of the genera Alternaria, Fusarium, Botrytis or Botryotinia, Sclerotinia, Dreschlera, Venturia, Hyaloperonospora, Plasmodiophora, Phoma, Erysiphe, Rhizoctonia, Pythium, Cercospora, Podosphaera, Gymnosporangium, Pythopthora, Plasmopara, Uncinula, Guignardia, Eutypa, Phomopsis, Botryosphaeria, Zymospetoria, Puccinia, Blumeria, Oculimacula, Gaeumannomyces, Pyrenophora, Phakospora, Septoria, Peronospora, Colletotrichum, Microsphaera, Corynespora, Helminthosporium, Pyricularia, Rhizoctonia, Sarocladium, Erythricium, Mycospharella, Urocystis, Monilinia, Taphrina, Cladosporium, Cytospora, Phomopsis, Cercosporidium, Phoma and Leptosphaerulina, preferably the at least one phytopathogenic fungal strain is selected from the genera Alternaria, Botrytis, Venturia, Erysiphe and Zymospetoria.

The method of the invention may further comprise applying on the plant organ at least one at least one PKc (Serine/Threonine Protein Kinase C) inhibitor, wherein the at least one at least one PKc inhibitor is applied simultaneously and/or sequentially to the composition comprising at least one UPR (Unfolded Protein Response) inhibitor; preferably said at least one PKc inhibitor is in a sub-effective amount, said sub-effective amount being a concentration equal or inferior to a non-fungicidal concentration C2; wherein the non-fungicidal concentration C2 is determined by comparing the growth of the phytopathogenic fungal strain cultures in contact with increasing concentrations of said at least one PKc inhibitor, with the growth of a control culture of the phytopathogenic fungal strain, in the absence of said at least one PKc inhibitor; the last concentration of the increasing concentrations of the at least one PKc inhibitor resulting in the same fungal culture growth as the control culture being retained as the non-fungicidal concentration C2 of said at least one PKc inhibitor

In some embodiments, the at least one PKc inhibitor is selected from the group consisting of chelerythrin, sanguinarin, berberin, coptisin a mixture thereof, and an extract of Macleaya cordata.

The method may further comprise applying on the plant organ simultaneously and/or sequentially to the composition comprising at least one UPR inhibitor, at least one agent for stimulating the synthesis of a plant defense molecule; said agent being selected from the group consisting of acibenzolar-S-methyl, chitosan, laminarin, Reynoutria sachalinensis extract, calcium prohexadione, harpine, yeast wall extracts, oligogalacturonides, calcium phosphonate, disodium phosphonate 24-Epibrassinolide, ABE-IT 56 (Yeast Extract), Cerevisane, Chito-oligosaccharides, Oligogalacturonides, Heptamaloxyloglucan, Pepino mosaic virus strain CH2 isolate 1906, Pythium oligandrum strain B301 and a mixture thereof.

The composition comprising the at least one UPR inhibitor to be applied may optionally further comprises at least synthetic or mineral phytopharmaceutical fungistatic or fungicide agent.

According to another aspect, the invention relates to a phytopharmaceutical composition against a phytopathogenic fungal strain, said phytopharmaceutical composition comprising at least one UPR (Unfolded Protein Response) inhibitor in a sub-effective amount, said at least one UPR inhibitor being selected from the group consisting of γ-mangostin, 1,3,5 trihydroxy-4-prenylxanthone, 1,3,5 trihydroxy-2-prenylxanthone and a mixture thereof, preferably the at least one UPR inhibitor being γ-mangostin; said sub-effective amount being a concentration ranging from 5 μM to 500 μM, preferably from 10 μM to 200 μM, more preferably from 15 μM to 100 μM, even more preferably from 30 μM to 75 μM, in association with at least one phytopharmaceutical vehicle.

In some embodiments of the composition, the sub-effective amount of the aforementioned at least one UPR inhibitor is a concentration ranging from 30 μM to 200 μM, more preferably from 30 μM to 100 μM, even more preferably from 35 μM to 75 μM.

The composition may further comprise at least one PKc inhibitor selected from the group consisting of chelerythrin, sanguinarin, berberin, coptisin and a mixture thereof and/or at least one agent for stimulating the synthesis of a plant defense molecule; said agent being selected from the group consisting of acibenzolar-S-methyl, chitosan, laminarin, Reynoutria sachalinensis extract, calcium prohexadione, harpine, yeast wall extracts, oligogalacturonides, calcium phosphonate, disodium phosphonate and a mixture thereof.

Lastly the composition may be in the form of a kit-of-parts that comprises a first part comprising at least one UPR (Unfolded Protein Response) inhibitor in a sub-effective amount as described above, a second part comprising least one phytopharmaceutical vehicle; and optionally a third part comprising at least one PKc inhibitor and/or a fourth part comprising at least one agent for stimulating the synthesis of a plant defense molecule as described above.

### DEFINITIONS

In the present invention, the following terms have the following meanings:

“About” preceding a figure means more or less 10% of the value of said figure.

“Agent for stimulating the production of a plant defense molecule” or “elicitor” refers to a compound that, when applied on a plant organ, leads to biochemical and/or physiologic cell reactions resulting in the synthesis, or to an increase of the synthesis of a plant defense molecule that is inherently expressed by the plant organs, such as, for example, a phytoalexin. Said agents may also be referred to as “natural defense stimulators”. Agents for stimulating the synthesis of a plant defense molecule are known in the prior art, and may be of natural (animal, vegetal or mineral) or synthetic origin. When these agents contact the plant organ, the plant defense signaling pathways are triggered, leading to the activation of the plant defense mechanisms. In that manner, plant defense molecules that are secreted may exert a synergistic effect with the composition of the present invention.

“Alkenyl”: refers to any linear or branched hydrocarbon chain having at least one double bond, of 2 to 15 carbon atoms. In one embodiment, the alkenyl is selected from methylene, ethylene, propylene, isopropylene, n-butylene, sec-butylene, isobutylene, tert-butylene, 2-methylpent-2-en-yl (also referred to as prenyl) and polymerized prenyl chains typically prenyl dimers and/or prenyl trimers.

“Alkyl”: refers to any saturated linear or branched hydrocarbon chain, with 1 to 12 carbon atoms, preferably 1 to 6 carbon atoms, and more preferably methyl, ethyl, propyl, isopropyl, n-butyl, sec-butyl, isobutyl and tert-butyl.

“Phytopharmaceutically effective amount” refers to the amount of an agent necessary and sufficient for, without causing significant negative or adverse side effects to the plant organ, (i) preventing a fungal infection, (ii) slowing down or stopping the progression, aggravation or deterioration of one or more symptoms of the fungal infection; (iii) alleviating said symptoms and/or (iv) eliminating fungal contamination in planta. Advantageously, the phytopharmaceutically effective amount is a sub-effective amount in vitro, typically a non-fungicidal-amount, in vitro.

“Controlling” means stopping the progression of the fungal infection, and preventing its spread across the healthy parts of the plant organ. In one embodiment, controlling refers to reducing the incidence a phytopathogenic infection, meaning decreasing the number of infected plant organs in a plant culture. In one embodiment, controlling refers to preventing the propagation of the fungal contamination from one plant to another plant of the same plant culture. In one embodiment, controlling refers to reducing the severity of a phytopathogenic infection, meaning decreasing the percentage of the infected surface (i.e. decolorized or necrotic surface) relative to the total plant organ surface.

“Plant defense molecule” refers to a molecule inherently expressed by a plant organ, belonging to the immune system of the plant and used by the plant organ to resist to an aggression, in particular a fungal infection. A plant defense molecule may thus be toxic for the phytopathogenic fungus infecting the plant organ. In one embodiment, a plant defense molecule is a molecule whose synthesis is not constitutive (i.e. the molecule is not synthesized at a constant level by the plant organ) but is induced by an aggression or an elicitor (inducer of pathogen resistance). In the context of the present invention, plant defense molecules may also be referred to as phytoalexins.

“Preventing” means avoiding occurrence of at least one adverse effect or symptom of a fungal infection.

“Treating” means eliminating fungal contamination, i.e. that there is no viable fungus in the plant organ anymore.

“Phytosanitary or phytopharmaceutical products” refers to active substances and preparations containing one or more active substances, intended to protect plant organs against a harmful organism or prevent the action of a harmful organism on plant organs.

“Phytopharmaceutical vehicle” refers to a vehicle that does not produce an adverse or other untoward reaction when applied on a plant organ. An example of phytopharmaceutical vehicle includes, but is not limited to, water.

“Plant organ” refers to a plant, a part of plant or a plant propagation material. Examples of plant organs include, but are not limited to, whole plants, leaves, stems, fruits, seeds, plants, part of plants, cuttings, tubers, roots, bulbs, rhizomes and the like.

“Synergistic effect”: defines the interaction of two or more agents acting together in a positive way to produce an effect in an amount that they could not separately reach. An “additive synergy” defines a synergy wherein the combined effect of the agents is equal to the sum of the effects of each agent alone. When the combined effect is greater than the sum of the effects of each agent operating by itself, the synergy is referred to as a “potentiating effect”. In one embodiment, the synergistic effect is an additive synergy. In another embodiment, the synergistic effect is a potentiating effect.

“Sub-effective amount” refers to the amount or the concentration of a compound/composition that does not exert a fungistatic and/or fungicidal effect. In one embodiment, the sub-effective amount refers to the in vitro sub-effective amount. In the context of the present specification the term amount may also designate concentration. As used herein, a “fungistatic effect” refers to an inhibiting and/or stopping and/or controlling effect upon the growth and/or development of fungi without destroying them, whereas a “fungicidal effect” refers to the destruction of fungi. In one typical embodiment, the sub-effective amount is a “non-fungicidal amount” that represents an amount (alternatively expressed as concentration) necessary to alter and/or inhibit the signaling pathways involved in the growth, stress-response and/or development of fungi, said amount being lower than a fungicidal amount. The non-fungicidal amount does not exert a fungicidal effect in vitro, and is lower than the in vitro fungicidal amount. In one typical embodiment, the sub-effective amount is a “non-fungistatic amount” that represents an amount (alternatively expressed as concentration) necessary to alter and/or inhibit the signaling pathways involved in the growth, stress-response and/or development of fungi, said amount being lower than a fungistatic amount. The non-fungistatic amount does not exert a fungistatic effect in vitro, and is lower than the in vitro fungistatic amount that typically is itself lower than the in vitro fungicidal amount. Methods for determining the sub-effective amount, typically the non-fungicidal amount of a product are well known from the skilled artisan. Examples of such methods include, but are not limited to, growth test in presence of increasing concentrations of said product, which may be carried out in culture in liquid or solid medium.

### DETAILED DESCRIPTION

According to a first aspect, the invention relates to a method for treating a plant organ, said method comprising the step of applying on the plant organ a composition comprising at least one inhibitor of the Unfolded Protein Response (UPR) signalization pathway (designated hereinafter as at least one UPR inhibitor), in particular an UPR inhibitor of formula (I) as hereinafter described, in a sub-effective amount.

As used herein, a “signalization pathway” refers to a network of proteins acting together to control one or more cell functions. After the first molecule of the pathway has received a signal, it activates another molecule. This process is repeated until the last molecule is activated and the cell function involved is carried out. One example of signalization pathway includes as a first molecule a transmembrane receptor, then a set of kinases, and at last a transcription factor.

Accordingly, an “inhibitor of a signalization pathway” is a compound that limits, prevents or stops the activation of anyone of the proteins of a signalization pathway, resulting in the incapacity of the pathway to control the cell function it usually controls. Referring to the example of the preceding paragraph, an inhibitor may act, without limitation, on the transmembrane receptor (for example, the inhibitor may be an agonist of said receptor), on the catalytic activity of a kinase (for example, the inhibitor may be a catalytic inhibitor of the enzymatic activity of the kinase) or may prevent the action of the transcription factor.

The UPR pathway is a stress signalization pathway involved in the cellular development and environmental adaptation in fungi, such as for example once they have been exposed to plant defense molecules. The UPR pathway is involved in regulating the folding, yield, and delivery of secretory proteins and that has consequences on the fungal stress response as well as on its virulence. This pathway is more particularly involved in maintaining the Endoplasmic Reticulum (ER) homeostasis. maintaining the fidelity of the protein folding activities of the endoplasmic reticulum (ER). Dysregulation of the UPR pathway may lead to a dysregulation of the protein homeostasis, also known as proteotoxic stress.

Proteins of the UPR pathway include, but are not limited to, endoribonuclease IRE1 (Inositol-Requiring Enzyme 1), transcription factor Hac1, and homologs of these proteins in filamentous fungi. Names of genes and proteins herein presented correspond to the genes and proteins of Saccharomyces cerevisiae. The skilled artisan knows how to identify the corresponding genes and proteins in another species of fungus.

Since aberrant polypeptides are deleterious to the cell, they are disposed of through ER-associated degradation (ERAD), a pathway that works in conjunction with the UPR to relieve the burden of unfolded proteins on the ER. ERAD recognizes unfolded proteins and escorts them through a channel in the ER membrane into the cytosol, where they are targeted for proteasomal degradation.

In one embodiment of the invention, the inhibitor of the UPR pathway is an inhibitor of the endoribonuclease IRE1 and/or of the transcription factor Hac1.

In one typical embodiment, the at least one UPR inhibitor is an inhibitor of Ire1. IRE1 is an ER membrane protein with a luminal stress sensing domain and a cytosolic effector domain that contains a protein kinase domain linked to an endoribonuclease (RNase). When unfolded protein levels are low, Ire1 is bound to the ER-resident Hsp70 chaperone BiP, which helps to maintain Ire1 in an inactive state. The presence of high levels of unfolded proteins triggers dissociation of BiP from Ire1, allowing for Ire1 oligomerization and trans-autophosphorylation. These events alter the conformation of Ire1, which activates the RNase domain leading to the destruction of aberrant proteins.

Without willing to be bound by a theory, applying the at least one UPR inhibitor according to the present invention leads to the blockade of the fungal stress resistance mechanisms that are triggered in response to the plant's defensive mechanisms, typically the plant defense molecules that are inherently expressed by the plant organs, in particular once infected by a phytopathogenic fungus, leading to the potentiation of the antifungal effects of the plant defense molecules and/or the effects of a phytopharmaceutical antifungal active agent as described herein, if such agent is applied. Advantageously, the at least one UPR inhibitor, typically the at least one IRE1 inhibitor, is in a sub-effective amount or concentration as defined hereinabove. Thus, the present invention leads to an antifungal treatment that does not present an inhibitory effect on fungi naturally present in the soil and water, thereby supplying an effective antifungal treatment that does not cause a disturbance of soil/water ecosystem.

It should be understood that, although the at least one UPR inhibitor is applied in an in vitro sub-effective amount, surprisingly it is effective in planta. In other terms, it was surprisingly found that the in vitro sub-effective amount of the at least one UPR inhibitor according to the invention is a phytopharmaceutically effective amount in planta. Indeed, it was surprisingly found by the inventors that the at least one UPR inhibitor according to the invention exerts a potentiating effect of the antifungal effects of several types of plant defense molecules that are inherently expressed by the plant organs. This potentiating effect was confirmed in vitro as well as in planta in various plant species, inherently expressing different plant defense molecules. This potentiating effect was confirmed in planta against various fungal infections and it was confirmed that the potentiating effect is effective in the prevention, the control and/or the treatment of various types of phytopathogenic fungi.

In one embodiment of the invention, the fungistatic or fungicidal effect in planta is measured after at least 5 hours of culture, preferably at least 10 hours, more preferably at least 20 hours, and even more preferably at least 30 hours.

In one embodiment of the invention, the fungistatic or fungicidal effect is assessed by comparing growth of treated fungi with growth of untreated fungi (controls cultured in the absence of the tested product) in vitro.

One example of such a method may be the following test:

Suspensions of fungal conidia (starting material being for example 10⁵ conidia/mL) are cultured in liquid medium, such as, for example, 300 μL of PBD medium, on microplate wells at 25° C. with shaking at 175 rpm for 5 minutes every 10 minutes. Increasing concentrations of the tested product are added on wells, and fungal growth is measured, during at least 5 hours, preferably at least 10, 20, 30 hours. Methods for measuring fungal growth are well known from the skilled artisan. Examples of such methods include, but are not limited to, photometry, such as, for example, spectrophotometric methods; or nephelometry, such as, for example, laser nephelometry as described in Joubert et al (Biotechniques, 2010, 48:399-404). Growth inhibition is measured by comparing the Area Under Curves (AUC) of treated samples and of untreated controls. Alternatively, the fungal conidia can be cultured on petri dishes with solid nutrient media such as PDA, inoculated with the phytopathogenic conidia, that are subjected to increasing concentrations of the tested product, followed by the determination of the growth inhibition by measuring the average growth diameter reduction of the phytopathogenic fungus strain culture. Still Alternatively, the fungistatic or fungicidal effect is assessed the so called “scotch” method wherein the phytopathogenic fungus is grown on the plant organ followed by the extraction of the conidia by an adhesive tape. Then the treatment can be applied, such as for example by spraying. Then the conidia were are observed using a microscope to determine their capacity to germinate and to form a germ tube. The growth inhibition is measure by measuring the germination rate of the conidia (direct effect) so as to determine the fungicidal concentration, typically the concentration C1 as hereinafter described.

Preferably, the sub-effective in vitro concentration is a concentration equal or inferior to a non-fungicidal concentration (concentration C1) of the at least one UPR inhibitor against a phytopathogenic fungal strain.

The non-fungicidal concentration C1 is determined by comparing the growth of the phytopathogenic fungal strain cultures in contact with increasing concentrations of said at least one UPR inhibitor, with the growth of a control culture of the phytopathogenic fungal strain, in the absence of said at least one UPR inhibitor; the last concentration of the increasing concentrations of the at least one UPR inhibitor resulting in a substantially identical fungal culture growth as the control culture being retained as the non-fungicidal concentration C1 of said at least one UPR inhibitor. In one embodiment, substantially identical designates the same fungal culture growth as the control culture. In one embodiment, the non-fungicidal concentration C1 does not exert more than 20% fungal growth inhibition compared to fungal growth of the control culture.

In order to attenuate bioavailability obstacles such as plant organ permeability regarding the at least one UPR inhibitor, the amount of the at least one UPR inhibitor may be adapted from about 1% to about 20%, or from about 5% to about 20% relative to the in-vitro determined non-fungicidal amount. Thus, in one embodiment, substantially identical fungal culture growth designates a more or less 5% fungal culture growth compared to the control culture. In one embodiment, substantially identical fungal culture growth designates a more or less 10% fungal culture growth compared to the control culture. In one embodiment, substantially identical fungal culture growth designates a more or less 15% fungal culture growth compared to the control culture. In one embodiment, substantially identical fungal culture growth designates a more or less 20% fungal culture growth compared to the control culture.

In some embodiments, the sub-effective amount or concentration is as described in each one of the following embodiments defining UPR inhibitors.

The at least one UPR inhibitor, typically the at least one IRE1 inhibitor, comprises a moiety of formula (I′):

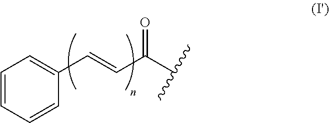

wherein n is 0 or 1, and wherein each position of the phenyl group may be substituted and/or part of a cycle.

According to the invention, the at least one UPR inhibitor, typically the at least one IRE1 inhibitor, is at least one xanthone as hereinafter detailed.

Xanthones or xanthonoids designate the compounds having 9H-Xanthen-9-one as a scaffold. Over 200 natural xanthones have been identified as natural products. Xanthones have been reported in plants of the non-exhaustive list of the families Bonnetiaceae, Clusiaceae, and Podostemaceae.

Xanthone compounds are typically represented by compounds of formula (I)

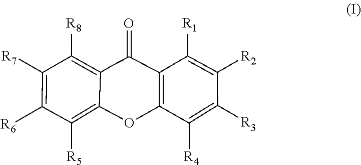

wherein each independently of R1, R2, R3, R4, R5, R6, R7 and R8 is selected from H, OH, alkenyl, alkyl, alkyl-oxy, and/or O-β-D-glucopyranose. Typically, alkenyl may be prenyl or genanyl. In some cases, the prenyl moiety may form with an ortho positioned hydroxyl (OH) moiety a five-membered ring or a six-membered ring, such as a 2,3,3-trimethyltetrahydrofuran ring, a 2,2-dimethyldihydropyrane ring, or a 2,2-dimethyldihydropyrane ring. As established by the organic chemistry IUPAC nomenclature, in ortho-substitution, two substituents occupy positions next to each other.

The inventors found that xanthones of formula (I) can inhibit the UPR pathway provided that they present at least one hydroxyl moiety in ortho position with at least one alkenyl moiety.

The at least one UPR inhibitor can be at least one xanthone of formula (I) wherein each independently of R1, R2, R3, R4, R5, R6, R7 and R8 is selected from H, OH, alkenyl, alkyl, alkyl-oxy, and/or O-β-D-glucopyranose, with the proviso that at least one of R1-R8 is OH, at least one of R1-R8 is alkenyl and said at least one OH and at least one alkenyl are in ortho position. In other terms, the at least one UPR inhibitor is at least one xanthone of formula (I) wherein each independently of R1, R2, R3, R4, R5, R6, R7 and R8 is selected from H, OH, alkenyl, alkyl, alkyl-oxy, and/or O-β-D-glucopyranose, with the proviso that at least one alkenyl moiety is in ortho position with at least one OH moiety.

Typically, each independently of R1, R2, R3, R4, R5, R6, R7 and R8 is selected from H, OH, alkenyl, and/or alkyl-oxy.

Typically, alkenyl can be selected from prenyl or geranyl. In one embodiment, alkenyl is prenyl. In one embodiment, alkenyl is geranyl. In one embodiment, alkyl-oxy is methoxy.

For instance:
each independently of R1, R2, R3, R4, R5, R6, R7 and R8 is selected from H, OH, alkenyl, typically prenyl, geranyl, and/or alkyl-oxy, typically methyl-oxy.
each independently of R1, R2, R3, R4, R5, R6, R7 and R8 is selected from H, OH, and/or alkenyl.
each independently of R1, R2, R3, R4, R5, R6, R7 and R8 is selected from H, OH, prenyl, and/or geranyl.
each independently of R1, R2, R3, R4, R5, R6, R7 and R8 is selected from H, OH, and/or prenyl.

According to one examples of xanthones of formula (I), each independently of R1, R2, R3, R4, R5, R6, R7 and R8 is selected from H, OH, alkenyl, alkyl, alkyl-oxy, and/or O-β-D-glucopyranose; preferably selected from H, OH, alkenyl, and/or alkyl-oxy, typically selected from H, OH, and/or alkenyl; and wherein:
R1 is OH, and R2 is alkenyl, preferably selected from prenyl and geranyl; and/or
R2 is hydroxyl, R1 and/or R3 is alkenyl, preferably selected from prenyl and geranyl; and/or
R3 is OH, R2 and/or R4 is alkenyl, preferably selected from prenyl and geranyl; and/or
R4 is OH, and R3 is alkenyl, preferably selected from prenyl and geranyl; and/or
R5 is OH, and R6 is alkenyl, preferably selected from prenyl and geranyl; and/or
R6 is OH, R5 and/or R7 is alkenyl, preferably selected from prenyl and geranyl; and/or
R7 is OH, R6 and/or R8 is alkenyl, preferably selected from prenyl and geranyl; and/or
R8 is OH, R2 and/or R4 is alkenyl, preferably selected from prenyl and geranyl.

According some examples of xanthones of formula (I), the prenyl moiety forms with the ortho positioned hydroxyl (OH) moiety a five-membered ring or a six-membered ring, selected from a 2,3,3-trimethyltetrahydrofuran ring, a 2,2-dimethyldihydropyrane ring, and a 2,2-dimethyldihydropyrane ring.

According some examples of xanthones of formula (I), the prenyl moiety forms a 2,3,3-trimethyltetrahydrofuran ring, with the-ortho positioned hydroxyl moiety. Thus, in one embodiment, the xanthone may be of formula (I) wherein each independently of R1, R2, R3, R4, R5, R6, R7 and R8 is selected from H, OH, alkenyl, alkyl, alkyl-oxy, and/or O-β-D-glucopyranose; preferably selected from H, OH, alkenyl, and/or alkyl-oxy, typically selected from preferably selected from H, OH, and/or alkenyl; and wherein:
R1 is OH, and R2 is prenyl, RI and R2 forming a 2,3,3-trimethyltetrahydrofuran ring; and/or
R2 is OH, and R1 is prenyl, RI and R2 forming a 2,3,3-trimethyltetrahydrofuran ring; and/or
R3 is OH, and R4 is prenyl, R3 and R4 forming a 2,3,3-trimethyltetrahydrofuran ring; and/or
R4 is OH, and R3 is prenyl, R4 and R3 forming a 2,3,3-trimethyltetrahydrofuran ring; and/or
R6 is OH, and R5 is prenyl, R6 and R5 forming a 2,3,3-trimethyltetrahydrofuran ring; and/or
R5 is OH, and R6 is prenyl, R5 and R6 forming a 2,3,3-trimethyltetrahydrofuran ring; and/or
R6 is OH, and R7 is prenyl, R6 and R7 forming a 2,3,3-trimethyltetrahydrofuran ring; and/or
R7 is OH, and R6 is prenyl, R7 and R6 forming a 2,3,3-trimethyltetrahydrofuran ring; and/or
R7 is OH, and R8 is prenyl, R7 and R8 forming a 2,3,3-trimethyltetrahydrofuran ring; and/or
R8 is OH, and R7 is prenyl, R8 and R7 forming a 2,3,3-trimethyltetrahydrofuran ring.

According some specific examples of xanthones of formula (I), R3 is OH, and R4 is prenyl, R3 and R4 forming a 2,3,3-trimethyltetrahydrofuran ring.

According a preferred embodiment of the invention, the at least one xanthone is selected from a xanthone of formula (I) wherein:
R2=R8: prenyl, R1=R3=R6=R7: OH, and R4=R5: H (γ-mangostin);
R1=R3=R5: OH, R2=R6=R7=R8: H, and R4: prenyl (1,3,5 trihydroxy-4-prenylxanthone);
R1=R3=R5: OH, R4=R6=R7=R8: H, and R2: prenyl (1,3,5 trihydroxy-2-prenylxanthone);
R1=R5=R6: OH, R2=R3=R4=R8: H, and R7: prenyl;
R8: geranyl, R1=R3=R6=R7: OH, and R4=R5: H (demethylrubraxanthone);
R1=R3=R4=R5: OH, R6=R7=R8: H, and R2: prenyl, wherein the R2 and R3 moieties form a 2,3,3-trimethyltetrahydrofuran ring/

More preferably, the at least one xanthone is selected from a xanthone of formula (I) wherein:
R1=R5=R6: OH, R2=R3=R4=R8: H, and R7: prenyl
R8: geranyl, R1=R3=R6=R7: OH, and R4=R5: H;
R1=R3=R4=R5: OH, R6=R7=R8: H, and R2: prenyl, wherein the R2 and R3 moieties form a 2,3,3-trimethyltetrahydrofuran ring.

Even more preferably, the at least one xanthone is selected from the group consisting of γ-mangostin, 1,3,5 trihydroxy-4-prenylxanthone, 1,3,5 trihydroxy-2-prenylxanthone, demethylrubraxanthone, and a mixture thereof.

Still more preferably, the at least one xanthone is selected from the group consisting of γ-mangostin, 1,3,5 trihydroxy-4-prenylxanthone, 1,3,5 trihydroxy-2-prenylxanthone and a mixture thereof. According to a yet more preferred embodiment, the at least one xanthone is γ-mangostin.

In one embodiment, the at least one UPR inhibitor is pure γ-mangostin such as for example at least 95% w/w, preferably at least 97% w/w, more preferably 99% w/w, still more preferably 100% w/w γ-mangostin in weight of the total xanthone UPR inhibitor weight. In one embodiment, the pure γ-mangostin is of synthetic origin or fractionated and purified γ-mangostin. According to a variant, the at least one UPR inhibitor does not comprises α-mangostin.

In one embodiment, the sub-effective amount of the at least one xanthone is less than 0.1% in weight relative to the total weight of the composition of the invention. preferably less than 0.7% in weight relative to the total weight of the composition of the invention. In one embodiment, the sub-effective amount of the at least one xanthone is less than or equal to 0.09% in weight relative to the total weight of the composition of the invention. In one embodiment, the sub-effective amount of the at least one xanthone is less than about 1000 ppm. In one embodiment, the sub-effective amount of the at least one xanthone is less than or equal to about 900 ppm, less than or equal to about 800 ppm, less than or equal to about 700 ppm, less than or equal to about 600 ppm, less than or equal to about 500 ppm. In one embodiment, the sub-effective amount of the at least one xanthone is less than or equal to about 2.52 mM. In one embodiment, the sub-effective amount of the at least one xanthone is less than or equal to about 2.50 mM. In one embodiment, the sub-effective amount of the at least one xanthone is less than or equal to about 2.43 mM. In one embodiment, the sub-effective amount of the at least one xanthone is less than or equal to about 2.30 mM, less than or equal to about 2.00 mM, less than or equal to about 1.50 mM, less than or equal to about 1.20 mM, less than or equal to about 1.00 mM. In one embodiment, the sub-effective amount of the at least one xanthone ranges from about 0.1 μM to about 2000 μM. In one embodiment, the sub-effective amount of the at least one xanthone ranges from about 1 μM to about 1500 μM. In one embodiment. the sub-effective amount of the at least one xanthone ranges from about 1 μM to about 1000 μM. In one embodiment, the sub-effective amount of the at least one xanthone ranges from about 1 μM to about 500 μM. In one embodiment, the sub-effective amount of the at least one xanthone ranges from about 1 μM to about 200 μM. In one embodiment, the sub-effective amount of the at least one xanthone ranges from about 1 μM to about 100 μM. In one embodiment, the sub-effective amount of the at least one xanthone ranges from about 1 μM to about 50 μM. In one embodiment, the sub-effective amount of the at least one xanthone ranges from about 2 μM to about 50 μM. In one embodiment, the sub-effective amount of the at least one xanthone ranges from about 2 μM to about 45 μM. In one embodiment, the sub-effective amount of the at least one xanthone ranges from about 2 μM to about 35 μM. In one embodiment, the sub-effective amount of the at least one xanthone ranges from about 2 μM to about 30 μM. In one embodiment, the sub-effective amount of the at least one xanthone ranges from about 2 μM to about 25 μM.

According to one embodiment, the sub-effective amount of the at least one xanthone ranges from 0.1 to 12.0 g of the at least one xanthone per hectare (Ha corresponding to 10,000 m²), preferably from 1.0 to 7.0 g, even more preferably from 4.0 to 6.0 g of the at least one xanthone per hectare of plant culture. It should be understood that, in the following embodiments, the plant culture refers to the field surface occupied by the plant culture. It should be also understood that the plant culture encompasses the plant organs to be treated according to the invention. In one embodiment, the sub-effective amount of the at least one xanthone ranges from 0.1 to 11.5 g/Ha of plant culture or from 0.1 to 11.0 g/Ha of plant culture. In one embodiment, the sub-effective amount of the at least one xanthone ranges from 0.1 to 10.5 g/Ha of plant culture or from 0.1 to 10.0 g/Ha of plant culture. In one embodiment, the sub-effective amount of the at least one xanthone ranges from 0.1 to 9.5 g/Ha of plant culture or from 0.1 to 9.0 g/Ha of plant culture. In one embodiment, the sub-effective amount of the at least one xanthone ranges from 0.1 to 8.5 g/Ha of plant culture or from 0.1 to 8.0 g/Ha of plant culture. In one embodiment, the sub-effective amount of the at least one xanthone ranges from 0.1 to 7.5 g/Ha of plant culture or from 0.1 to 7.0 g/Ha of plant culture. In one embodiment, the sub-effective amount of the at least one xanthone ranges from 0.1 to 6.5 g/Ha of plant culture or from 0.1 to 6.0 g/Ha of plant culture. In one embodiment, the sub-effective amount of the at least one xanthone ranges from 0.1 to 5.5 g/Ha of plant culture or from 0.1 to 5.0 g/Ha of plant culture. In one embodiment, the sub-effective amount of the at least one xanthone ranges from 0.1 to 4.5 g/Ha of plant culture or from 0.1 to 4.0 g/Ha of plant culture. In one embodiment, the sub-effective amount of the at least one xanthone ranges from 0.1 to 3.5 g/Ha of plant culture or from 0.1 to 3.0 g/Ha of plant culture. In one embodiment, the sub-effective amount of the at least one xanthone ranges from 0.1 to 3.3 g/Ha of plant culture or from 0.1 to 3.2 g/Ha of plant culture. In one embodiment, the sub-effective amount of the at least one xanthone ranges from 0.1 to 2.5 g/Ha of plant culture or from 0.1 to 2.0 g/Ha of plant culture. In one embodiment, the sub-effective amount of the at least one xanthone ranges from 0.1 to 1.5 g/Ha of plant culture or from 0.1 to 1.0 g/Ha of plant culture. In one embodiment, the sub-effective amount of the at least one xanthone ranges from 0.1 to 0.5 g/Ha of plant culture.

As discussed herein above, in one preferred embodiment, the at least one xanthone is γ-mangostin. γ-mangostin is also referred to as normangostin and designates 1,3,6,7-tetrahydroxy-2,8-bis(3-methylbut-2-enyl)xanthen-9-one (CAS N° 31271-07-5) having a molecular weight of 396.4 g/mol and the structure of formula Ia. With respect to formula (I) γ-mangostin presents R2=R8: prenyl, R1=R3=R6=R7: OH, and R4=R5: H.

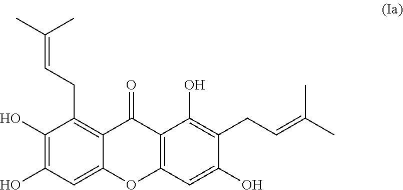 [SMILES: CC(C)=CCc1c(O)cc2oc3cc(O)c(O)c(CC=C(C)C)c3c(=O)c2c1O]

In one embodiment, the sub-effective amount of γ-mangostin is less than 0.1%, preferably less or equal to 0.05%, even more preferably less or equal to 0.03% in weight relative to the weight of the total composition of the invention. In one embodiment, the sub-effective amount of γ-mangostin is less than about 1000 ppm. In one embodiment, the sub-effective amount of γ-mangostin is less than or equal to about 900 ppm, less than or equal to about 800 ppm, less than or equal to about 700 ppm, less than or equal to about 600 ppm, less than or equal to about 500 ppm. In one embodiment, the sub-effective amount of γ-mangostin is less than about 2.52 mM. In one embodiment, the sub-effective amount of γ-mangostin is less than or equal to about 2.50 mM, is less than or equal to about 2.30 mM, less than or equal to about 2.00 mM, less than or equal to about 1.50 mM, less than or equal to about 1.20 mM, less than or equal to about 1.00 mM. In one embodiment, the sub-effective amount of γ-mangostin ranges from about 0.1 μM to about 2000 μM. In one embodiment, the sub-effective amount of γ-mangostin ranges from about 1 μM to about 1500 μM. In one embodiment, the sub-effective amount of γ-mangostin ranges from about 1 μM to about 1000 μM. In one embodiment, the sub-effective amount of γ-mangostin ranges from about 1 μM to about 500 μM. In one embodiment, the sub-effective amount of γ-mangostin ranges from about 1 μM to about 200 μM. In one embodiment, the sub-effective amount of γ-mangostin ranges from about 1 μM to about 100 μM, typically from more than 25 μM to about 75 μM.

According to a preferred embodiment, the sub-effective amount of γ-mangostin ranges from about 30 μM to about 500 μM, preferably from about 30 μM to about 200 μM, more preferably from about 30 μM to about 100 μM, even more preferably from about 35 μM to about 75 μM, still more preferably from about 50 μM to about 75 μM.

In some exemplary embodiments, the sub-effective amount of γ-mangostin ranges from about 1 μM to about 50 μM, from about 2 μM to about 50 μM or from about 2 μM to about 45 μM. In one embodiment, the sub-effective amount of γ-mangostin ranges from about 2 μM to about 35 μM. In one embodiment, the sub-effective amount of γ-mangostin ranges from about 2 μM to about 30 μM. In one embodiment, the sub-effective amount of γ-mangostin ranges from about 2 μM to about 25 μM.

In one embodiment, the at least one xanthone is 1,3,5 trihydroxy-4-prenylxanthone. 1,3,5 trihydroxy-4-prenylxanthone designates 1,3,5-trihydroxy-4-(3-methylbut-2-enyl)xanthen-9-one (CAS N° 53377-61-0) having a molecular weight of 312.3 g/mol and the structure of formula Ic. With respect to formula (I) 1,3,5 trihydroxy-4-prenylxanthone presents R1=R3=R5: OH, R2=R6-R7=R8: H, and R4: prenyl.

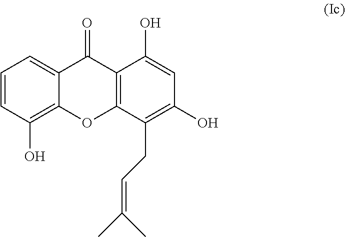 [SMILES: CC(C)=CCc1c(O)cc(O)c2c(=O)c3cccc(O)c3oc12]

In one embodiment, the at least one xanthone is 1,3,5 trihydroxy-2-prenylxanthone. 1,3,5 trihydroxy-2-prenylxanthone also known as isombarraxanthone designates 1,3,5-trihydroxy-2-(3-methylbut-2-enyl)xanthen-9-one (CAS N° 20245-39-2) having a molecular weight of 312.3 g/mol and the structure of formula (Id). With respect to formula (I) 1,3,5 trihydroxy-2-prenylxanthone presents R1=R3=R5: OH, R4=R6=R7=R8: H, and R2: prenyl.

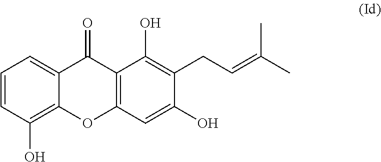 [SMILES: CC(C)=CCc1c(O)cc2oc3c(O)cccc3c(=O)c2c1O]

In one embodiment, the sub-effective amount of the compound of formula (Ic) or the compound of formula (Id) is less than 0.1% in weight relative to the weight of the weight of the total composition of the invention. In one embodiment, the sub-effective amount of the compound of formula (Ic) or the compound of formula (Id) is less than or equal to 0.09% in weight relative to the weight of the total composition of the invention. In one embodiment, the sub-effective amount of the compound of formula (Ic) or the compound of formula (Id) is less than about 1000 ppm. In one embodiment, the sub-effective amount of the compound of formula (Ic) or the compound of formula (Id) is less than or equal to about 900 ppm, less than or equal to about 800 ppm, less than or equal to about 700 ppm, less than or equal to about 600 ppm, less than or equal to about 500 ppm. In one embodiment, the sub-effective amount of the compound of formula (Ic) or the compound of formula (Id) is less than about 3.20 mM, is less than about 3.10 mM, less than 3.00 mM, less than 2.70 mM or less than 2.50 mM. In one embodiment, the sub-effective amount of the compound of formula (Ic) or the compound of formula (Id) is less than or equal to about 2.40 mM, is less than or equal to about 2.30 mM, less than or equal to about 2.00 mM, less than or equal to about 1.50 mM, less than or equal to about 1.20 mM, less than or equal to about 1.00 mM. In one embodiment, the sub-effective amount of the compound of formula (Ic) or the compound of formula (Id) ranges from about 0.1 μM to about 2000 μM. In one embodiment, the sub-effective amount of the compound of formula (Ic) or the compound of formula (Id) ranges from about 1 μM to about 1500 μM. In one embodiment, the sub-effective amount of the compound of formula (Ic) or the compound of formula (Id) ranges from about 1 μM to about 1000 μM. In one embodiment, the sub-effective amount of the compound of formula (Ic) or the compound of formula (Id) ranges from about 1 μM to about 500 μM. In one embodiment, the sub-effective amount of the compound of formula (Ic) or the compound of formula (Id) ranges from about 1 μM to about 200 μM. In one embodiment, the sub-effective amount of the compound of formula (Ic) or the compound of formula (Id) ranges from about 1 μM to about 100 μM. In one embodiment, the sub-effective amount of the compound of formula (Ic) or the compound of formula (Id) ranges from about 1 μM to about 50 μM. In one embodiment, the sub-effective amount of the compound of formula (Ic) or the compound of formula (Id) ranges from about 2 μM to about 50 μM. In one embodiment, the sub-effective amount of the compound of formula (Ic) or the compound of formula (Id) ranges from about 2 μM to about 45 μM. In one embodiment, the sub-effective amount of the compound of formula (Ic) or the compound of formula (Id) ranges from about 2 μM to about 35 μM. In one embodiment, the sub-effective amount of the compound of formula (Ic) or the compound of formula (Id) ranges from about 2 μM to about 30 μM. In one embodiment, the sub-effective amount of the compound of formula (Ic) or the compound of formula (Id) ranges from about 2 μM to about 25 μM.

According to one embodiment, the at least one UPR inhibitor is an extract of a Clusiaceae plant extract, comprising γ-mangostin. Typically, the Clusiaceae plant extract is a Garcinia mangostana plant extract, preferably selected from Garcinia mangostana leaf, bark or pericarp extract. Preferably, the extract is a Garcinia mangostana pericarp extract. In one embodiment, the extract is an enriched extract, preferably an xanthone-enriched extract or fraction, even more preferably a γ-mangostin-enriched extract or a γ-mangostin-rich extract fraction. Numerous techniques are known in the art for obtaining such enriched extract or extract fraction such as for example, liquid-liquid extraction/partitioning or adsorption/absorption chromatography.

In one embodiment, such extract is an aqueous extract, an hydroalcoholic extract, an ethanolic extract, a methanolic extract, an ethyl acetate extract or a supercritical CO₂ extract. In one embodiment, the extract is obtained with a mixture of ethyl acetate and ethanol, typically in a ethyl acetate:ethanol volume ratio ranging from 60:40 to 90:10, from 70:30 to 80:20, from 75:25 to 80:20. In one specific, embodiment, the extract is obtained with a mixture of ethyl acetate and ethanol, in a ethyl acetate:ethanol volume ratio of about 75:25, of about 76:24, of about 77:23, of about 78:22, of about 79:21, or of about 80:20.

In one embodiment, the above extracts can be obtained by ultrasound or microwave assisted extraction methods.

In one embodiment, the extract is a crude extract of the plant or a fractionated part thereof. Any means, such as chromatographic means that are known in the art may be used to fractionate a crude extract such as for example, liquid-liquid extraction/partitioning and/or adsorption/absorption chromatography.

Typically, the Garcinia mangostana pericarp crude extract comprises from 10 to 15% w/w of γ-mangostin in dry weight relative to the dry weight of the crude extract. For instance, 100 mg of G. mangostana crude dry extract comprise about 25 μmol of γ-mangostin.

It is understood that fractionated parts of the crude extract may comprise γ-mangostin in different concentrations. The Garcinia mangostana pericarp crude extract may further comprise xanthones according to the present invention such as 1,3,5 trihydroxy-4-prenylxanthone, 1,3,5 trihydroxy-2-prenylxanthone. The Garcinia mangostana pericarp crude extract may further comprise xanthones that do not fall in the scope of the present invention such as α-mangostin. Advantageously, the Garcinia mangostana pericarp crude can be used at a concentration wherein all its constituents are in an in vitro non-fungicidal amount such as for example less than 200 mg/L, less than 150 mg/L or less than 100 mg/mL. It is of note that the skilled artisan can adapt these non-fungicidal amounts if a γ-mangostin-rich or γ-mangostin-poor fraction is used instead of a Garcinia mangostana pericarp crude extract.

According to some disclosed embodiments, the at least one UPR inhibitor, typically the at least one IRE1 inhibitor, is at least one naphthoquinone.

Naphthoquinones is a class of organic compounds structurally related to naphthalene. Two isomers are common for the parent naphthoquinone: 1,2 naphthoquinone and 1,4 naphthoquinone. In a preferred embodiment, the UPR inhibitor is a 1,4 naphthoquinone.

The at least one naphthoquinone can be selected from the group consisting of alkannin, hexahydroxy-1,4-naphthalenedione, juglone, lapachol, lawsone, menatetrenone, 2-methoxy-1,4-naphthoquinone, nigrosporin B, 2,3,5,6,8-pentahydroxy-1,4-naphthalenedione, phylloquinone, plumbagin and 2,3,5,7-tetrahydroxy-1,4-naphthalenedione or a combination thereof.

According to the disclosed embodiments, the at least one UPR inhibitor can be at least one naphthoquinone of formula (II):

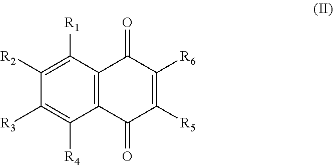

wherein each independently of R1, R2, R3, R4, R5 and R6, is selected from H, OH, alkenyl, alkyl, alkyl-oxy, and/or O-β-D-glucopyranose.

Typically each independently of R1-R6 is selected from H, OH, alkyl selected from methyl and/or ethyl, alkyl-oxy selected from methyl-oxy and/or ethyl-oxy, O-β-D-glucopyranose or prenyl (2-methylpent-2-en-yl).

Typically R5=R6: H and R1-R4 is each independently selected from H, OH, methyl, methyl-oxy, or O-β-D-glucopyranose. In some disclosed embodiments, R6: H and R1-R5 is each independently selected from H, OH, methyl-oxy, and/or O-β-D-glucopyranose. In some embodiments, R5=R6: H and R1-R4 is each independently selected from H, OH, methyl-oxy, and/or O-β-D-glucopyranose. In some disclosed embodiments, R5=R6: H and R1-R4 is each independently selected from H, OH, methyl, and/or methyl-oxy.

The at least one naphthoquinone according to the disclosed embodiments can be selected from juglone, lawsone and/or plumbagin. For example, the at least one naphthoquinone can be juglone.

Juglone designates 5-hydroxy-1,4-naphthalenedione. Juglone corresponds to a compound of formula (IIa) and to a compound of formula (II) wherein R1=R2=R3=R5=R6 are H and R4 is OH.

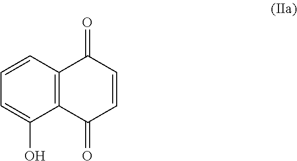 [SMILES: O=C1C=CC(=O)c2c(O)cccc21]

Juglone has the CAS N° 481-39-0. Juglone is also known as 5-hydroxy-1,4-naphthoquinone, 5-hydroxy-p-naphthoquinone, regianin, 5-hydroxynaphthoquinone, nucin, NCI 2323, Oil Red BS, or C.I. Natural Brown 7. Juglone occurs naturally in the leaves, roots, husks, fruit (the epicarp), and bark of plants in the Juglandaceae family, particularly the black walnut (Juglans nigra).

In one disclosed embodiment, the at least one naphthoquinone, typically juglone, is in the form of a Juglandaceae family plant extract. In one further disclosed embodiment, the plant is Juglans nigra or Juglans regia. Typically, the Juglandaceae family plant extract is a leaf, husk and/or pericarp extract of Juglans nigra and/or Juglans regia. Such extract can be an aqueous extract, an hydroalcoholic extract, an ethanolic extract, a methanolic extract, an ethyl acetate extract or a supercritical CO₂ extract.

In one disclosed embodiment, the sub-effective amount of the at least one naphthoquinone, typically of juglone or the Juglandaceae family plant extract, is less than or equal to 10% in weight relative to the weight of the total composition of the disclosed embodiments. For example, the sub-effective amount of juglone or the Juglandaceae plant extract is less than or equal to 9%, less than or equal to 8%, less than or equal to 7%, less than or equal to 6%; less than or equal to 5%; less than or equal to 3%, less than or equal to 2%, less than or equal to 1% or less than or equal to 0,5%, in weight relative to the weight of the total composition of the disclosed embodiment. For instance, the sub-effective amount of juglone or is less than or equal to 0.1 μM. In one embodiment, the sub-effective amount of juglone or is less than or equal to 0.05 μM.

In another disclosed embodiment, the at least one UPR inhibitor, typically the at least one IRE1 inhibitor, is at least one phenolic acid ester.

The at least one phenolic acid ester can be a phenolic acid ester of formula (III)

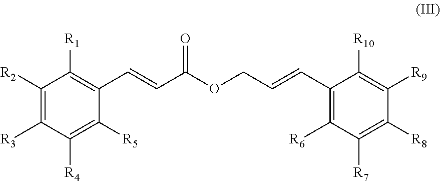

wherein each independently of R1-R10 is selected from H, OH, alkyl-oxy, typically methyl-oxy, and/or O-β-D-glucopyranose.

Typically, the phenolic acid ester can be selected from esters of caffeic acid (3-(3,4-dihydroxyphenyl)-2-propenoic acid), esters of 4-hydroxycinnamic acid (3-(4-hydroxyphenyl)-2-propenoic acid) and/or esters of ferulic acid ((3-(4-hydroxy-3-methoxyphenyl) prop-2-enoic acid) esters. Typically, the at least one phenolic acid ester is a caffeic acid ester.

Caffeic acid is an organic compound that is classified as a hydroxycinnamic acid. It is found in all plants because it is an intermediate in the biosynthesis of lignin, one of the principal components of woody plant biomass and its residues. It has no connection with caffeine, but occurs naturally in small amounts in coffee in the free state and in very large amounts in the esterified state.

In one exemplary embodiment, the at least one phenolic acid ester is caffeic acid ester of formula (IIIa)

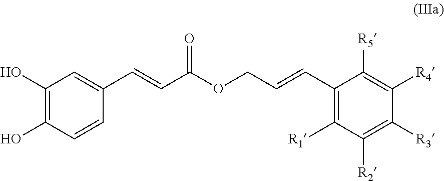

wherein each independently of R1′-R5′ is selected from H, OH, alkyl-oxy, typically methyl-oxy, and/or O-β-D-glucopyranose.

For instance, the caffeic acid ester can be cinnamyl caffeate.

Cinnamyl caffeate refers to [(E)-3-phenylprop-2-enyl] (E)-3-(3,4-dihydroxyphenyl)prop-2-enoate (CAS N° 115610-32-7) having a molecular weight of 296.3 g/mol and the structure of formula IIIb. Cinnamyl caffeate may also be referred to as Cinnamyl (E)-3-(3,4-dihydroxyphenyl)acrylate, 3,4-Dihydroxycinnamic acid 3-phenyl-2-propenyl ester or 3-(3,4-Dihydroxyphenyl)propenoic acid 3-phenyl-2-propenyl ester. With respect to formula (IIIa) cinnamyl caffeate presents R1′=R2′=R3′=R4′=R5′: H.

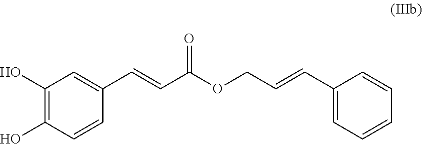 [SMILES: O=C(/C=C/c1ccc(O)c(O)c1)OC/C=C/c1ccccc1]

In one further disclosed embodiment, the at least one UPR inhibitor, typically the at least one IRE1 inhibitor, is at least one oxoaporphine alkaloid.

Several naturally occurring oxoaporphines with the debenzoquinoline skeleton are presently known. They have been reported in plant species of the families Anonaceae, Araceae, Hernandiaceae, Lauraceae, Magnoliaceae, Menispermaceae, Monimiaceae, Papaveraceae, and Ranunculaceae.

In one disclosed embodiment, the at least one oxoaporphine alkaloid is a compound of formula (IV)

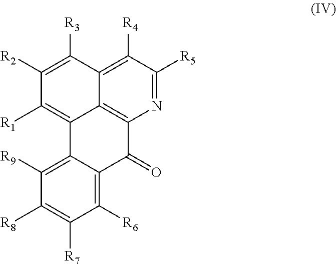

wherein:
R1 and R2 are such that
   R1 is selected from H, OH, or an alkyl-oxy, typically a methyl-oxy; and R2 is selected from H, OH, or an alkyl-oxy, typically a methyl-oxy; or
   R1 and R2 together form a ring comprising 5 or 6 atoms, preferably a heterocycle comprising 5 or 6 atoms, more preferably a dioxolane;
R3, R4, R5 and R6 are each independently selected from H, OH, or an alkyl-oxy, typically a methyl-oxy; and
R7, R8 and R9 are such that
   R7 is selected from H, OH, or an alkyl-oxy, typically a methyl-oxy;
   R8 is selected from H, OH, or an alkyl-oxy, typically a methyl-oxy; and
   R9 is selected from H, OH, or an alkyl-oxy, typically a methyl-oxy; or
   R7 and R8 together form a ring comprising 5 or 6 atoms, preferably a heterocycle comprising 5 or 6 atoms, more preferably a dioxolane; and R9 is selected from H, OH, or an alkyl-oxy, typically a methyl-oxy; or
   R8 and R9 together form a ring comprising 5 or 6 atoms, preferably a heterocycle comprising 5 or 6 atoms, more preferably a dioxolane; and R7 is selected from H, OH, or an alkyl-oxy, typically a methyl-oxy.

Typically, the at least one oxoaporphine alkaloid can be oxostephanine. Oxostephanine refers to the compound: 15-methoxy-3,5-dioxa-11-azapentacyclo [10.7.1.0^{2,6}.0^{8,20}.0^{14,19}]icosa-(20),2(6),7,9,11,14(19),15,17-octaen-13-one of formula (IVa)

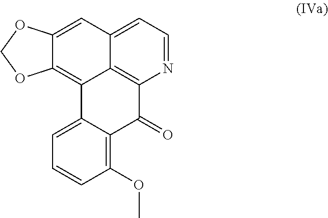 [SMILES: COc1cccc2c1C(=O)c1nccc3cc4c(c-2c13)OCO4]

Oxostephanine has a molecular weight of 305.3 g/mol (CAS N° 58262-58-1). Oxostephanine presents formula (IV) wherein:
R1 and R2 form a dioxolane ring,
R3, R4, and R5 are H,
R6 is methyl-oxy,
R7, R8 and R9 are H.

According to a further disclosed embodiment, the at least one UPR inhibitor is an extract of a Menispermaceae and/or Annonaceae plant extract, comprising at least one compound of formula (IV). In one embodiment, the Menispermaceae and/or Annonaceae plant extract comprises oxostephanine. Typically, the Menispermaceae plant extract is a Stephania spp plant extract, such as for example S. venosa, S. dielsiana, S. rotunda. The extract can be a leaf, bark or pericarp extract. Such extract can be an aqueous extract, an hydroalcoholic extract, an ethanolic extract, a methanolic extract, an ethyl acetate extract or a supercritical CO₂ extract. Typically, the extract can be a crude extract of the plant or a fractionated part thereof as described above.

In one embodiment, the composition comprises at least two, at least, at least three or at least four or more UPR inhibitors selected from:
at least one xanthone of formula (I) as defined above or a plant extract comprising thereof as defined above, preferably the at least one xanthone of formula (I) being selected from γ-mangostin, 1,3,5 trihydroxy-4-prenylxanthone, and/or 1,3,5 trihydroxy-2-prenylxanthone, even more preferably the at least one xanthone of formula (I) is γ-mangostin, typically in the in vitro sub-effective amount defined above,
at least one naphthoquinone of formula (II) as defined above, or a plant extract comprising thereof as define above, preferably the at least one naphthoquinone of formula (II) being juglone, typically in the in vitro sub-effective amount defined above,
at least one phenolic acid ester of formula (III) as defined above or a plant extract comprising thereof as define above, preferably the at least one phenolic acid ester being phenolic acid ester of formula (IIIa) as defined above, even more preferably the at least one phenolic acid ester being cinnamyl caffeate, typically in the in vitro sub-effective amount defined above, and
at least one oxoaprphine alkaloid of formula (IV) as defined above or a plant extract comprising thereof as define above, preferably the at least one oxoaporphine alkaloid of formula (IV) being oxostephanine, typically in the in vitro sub-effective amount defined above,

In one embodiment, the composition comprising the at least one UPR inhibitor, as described above, further comprises at least one phytopharmaceutical vehicle. The composition may therefore be a phytopharmaceutical composition.

In one embodiment, the composition of the invention is in a solid form, such as, for example, granules, wettable powders, water dispersible granules or powders and the like.

In another embodiment, the composition of the invention is in a liquid form, such as, for example, a suspension, a solution or an emulsion, such as, for example, an oil-in-water emulsion or a water-in-oil emulsion.

In one embodiment, the composition may be formulated as a concentrate to be diluted, such as, for example, a soluble concentrate, an emulsifiable concentrate, and the like.

In one embodiment, the composition may comprise additional agents, such as, for example, natural or regenerated mineral substances, solvents, dispersants, solid carriers, surfactants, wetting agents, tackifiers, thickeners, and/or binders.

Examples of solvents include, but are not limited to, aromatic hydrocarbons, such as, for example, xylene mixtures or substituted naphthalenes; phthalates, such as, for example, dibutyl phthalate or dioctyl phthalate; aliphatic hydrocarbons, such as, for example, cyclohexane or paraffins; alcohols and glycols and their ethers and esters, such as, for example, ethanol, ethylene glycol, ethylene glycol monomethyl or monoethyl ether; ketones, such as, for example, cyclohexanone; strongly polar solvents, such as, for example, N-methyl-2-pyrrolidone, dimethyl sulfoxide or dimethylformamide; vegetable oils or epoxidised vegetable oils, such as, for example, epoxidised coconut oil or soybean oil; and water.

Examples of solid carriers include, but are not limited to, natural mineral fillers, such as, for example, calcite, talcum, kaolin, montmorillonite or attapulgite; highly dispersed silicic acid or highly dispersed absorbent polymers; pumice, broken brick, sepiolite or bentonite; calcite or sand; dolomite or pulverized plant residues.

Examples of surfactants include, but are not limited to, anionic surfactants including; alkylsulfosuccinic acid salts, condensated phosphate acid salts, alkylbenzenesulfonic acid salts such as, for example, dodecylbenzenesulfonic acid sodium salt, alkylnaphthalenesulfonic acid salts, formalin condensates of naphthalenesulfonic acid salts, ligninsulfonic acid salts, polycarboxylic acid salts, alkylethersulfuric acid salts, polyoxyethylene-alkylarylphenylether-sulfuric acid salts, polyoxyethylene-alkylarylether-sulfuric acid salts, polyoxyethylene-alkylaryl-sulfuric acid salts, polyoxyethylene-alkylaryether-sulfate ester salts, polyoxyethylene-alkylarylether-acetate ester-sulfuric acid salts; nonionic surfactants such as, for example, polyoxyethylene-alkylether, polyoxyethylene-alkylarylether, polyoxyethylene-alkylarylphenylether, polyoxyethylene-styrylphenylether, polyoxyethylene-alkyl ester, sorbitan-alkyl-ester, polyoxyethylene-sorbitanalkyl-ester, and polyoxyethylene-polyoxypropyleneglycol. As used herein, the salt form includes alkali-metal salts, ammonium salts, and amine salts.

In one embodiment, the method further comprises applying at least one inhibitor of Serine/Threonine kinase PKc (Protein Kinase C) that is hereinafter designated as at least on PKc inhibitor. In one embodiment, the at least one PKc inhibitor is applied simultaneously or sequentially to the composition comprising at least one UPR inhibitor. In one embodiment, when the PKc inhibitor is applied simultaneously with the composition comprising at least one UPR inhibitor, the composition of the invention comprises the at least one UPR inhibitor and further comprises said at least one PKc inhibitor.

Methods for identifying PKc inhibitors are well known of the skilled artisan. An example of such method includes, but is not limited to, measuring the kinase activity of (partially) purified PKc in presence of increasing amounts of potential inhibitors. Useful kits for measurement of PKc activity may be selected among PepTag Assay (Promega), MESACUP PKA/PKC assay kit; Cyclex PKc superfamily kinase assay kit (MBL); Protein kinase C assay kits (PANVERA); Z′-Lyte FRET based kinase assay (Invitrogen); Omnia assay kit (Invitrogen).

Examples of inhibitors of PKc include, but are not limited to, chelerythrin, chelerythrin chloride, chelerythrine sulphate, sanguinarine sulphate, 3-(1H-indol-3-yl)-4-[2-(4-methylpiperazin-1-yl) quinazolin-4-yl]pyrrole-2,5-dione (AEB071), 13-HODE, AEB-071, Annexin V, Aprinocarsen, ARC, Bisindolylmaleimide GF 109203X, bisphosphonate, Bryostatin-1, BSP-A1/-A2, Butein, Calphostin C, Curcumin, Daphnetin, Dexamethasone, Enzastaurin, Erbstatin, GO6976, H-7 Hispidin, Hypocrellin A, hypericin, LY333531, Midostaurin, MT477, N-myristyl-Lys-Arg-Thr-Leu-Arg, NPC 15437, PAP, PKC412, R8605, RK-286C, Ro 31-8220, Rottlerin, ruboxistaurin, Sotrastaurin, Staurosporine, UCN-01, UCN-02, Vanicosides A and B, and Verbascoside.

Examples of PKc inhibitors also include, but are not limited to, compounds of general formula (V), (VI) or (VII) as hereinafter described. In one specific embodiment, the at least one PKc inhibitor is selected from the group consisting of chelerythrine, sanguinarine, berberine and/or coptisine. In one specific embodiment, the at least one PKc inhibitor is selected from the group consisting of chelerythrine and sanguinarine. In one specific embodiment, the at least one PKc inhibitor is selected from the group consisting of berberine and coptisine.

In one embodiment of the invention, the at least one PKc inhibitor is an isoquinoline of general formula (V):

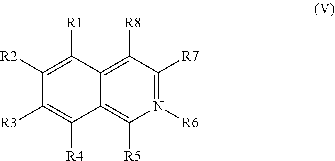

wherein:
each of R1 to R5 independently is H, OH, a halogen atom, an alkyl, an alkyl-oxy or an alkenyl group;
R6 is absent or is present and when present, R6 may be H, OH, an alkyl, an alkyl-oxy or an alkenyl group; when R6 is present, a counterion may be preferably selected from the group comprising Cl⁻, CH₃SO₃⁻, HSO₄⁻, I⁻, HCO₃⁻, BF₄⁻ or PF₆⁻; and
R7 and R8 are independently H, OH, a halogen atom, an alkyl, an alkyl-oxy or an alkenyl group or R7 and R8 form together a ring, preferably a substituted ring, more preferably a substituted or unsubstituted naphthalene, a substituted or unsubstituted isoquinoline.

In one embodiment of the invention, R3 and R4 and/or R6 and R7 and/or R7 and R8, together form a ring, preferably comprising 5 or 6 atoms. In one embodiment, said ring may be substituted.

In one embodiment, the compound of general formula (V) is such that R7 and R8 together form a ring, preferably a substituted ring, more preferably a substituted naphthalene. According to this embodiment, the at least one PKc inhibitor of a plant defense molecule is a benzo[c]phenantridine of general formula (VI):

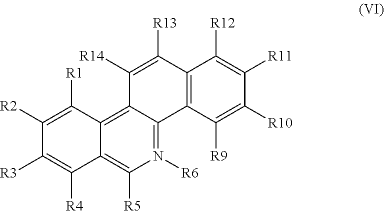

wherein:
R1 is H, OH, a halogen atom, an alkyl, an alkyl-oxy or an alkenyl group, preferably R1 is H;
R2 is H, OH, a halogen atom, an alkyl, an alkyl-oxy or an alkenyl group, preferably R2 is H or methyl-oxy;
R3 and R4 are such that
   R3 is H, OH, a halogen atom, an alkyl, an alkyl-oxy or an alkenyl group; preferably R3 is methyl-oxy; and R4 is H, OH, a halogen atom, an alkyl, an alkyl-oxy or an alkenyl group, preferably R4 is H or methyl-oxy; or
   R3 and R4 together form a ring comprising 5 or 6 atoms, preferably a heterocycle comprising 5 or 6 atoms, more preferably a dioxolane;
R5 is H, OH, a halogen atom, an alkyl, an alkyl-oxy or an alkenyl group, preferably R5 is H;
R6 is absent or is present and when present, R6 may be H, OH, an alkyl, an alkyl-oxy or an alkenyl group, preferably R6 is absent or CH₃; when R6 is present, a counterion may be preferably selected from the group comprising Cl⁻, CH₃SO₃⁻, HSO₄⁻, I⁻, HCO₃⁻, BF₄⁻ or PF₆⁻;
R9 is H, OH, a halogen atom, an alkyl, an alkyl-oxy or an alkenyl group, preferably R9 is H;
R10 and R11 are such that
   R10 is H, OH, an alkyl, an alkyl-oxy, a halogen atom or an alkenyl group, preferably R10 is methyl-oxy; and R11 is H, OH, an alkyl, an alkyl-oxy, a halogen atom or an alkenyl group, preferably R11 is methyl-oxy; or
   R10 and R11 together form a ring comprising 5 or 6 atoms, preferably a heterocycle comprising 5 or 6 atoms, more preferably a dioxolane;
R12 is H, OH, a halogen atom, an alkyl, an alkyl-oxy or an alkenyl group, preferably R12 is H;
R13 is H, OH, a halogen atom, an alkyl, an alkyl-oxy or an alkenyl group, preferably R13 is H or O—CH₂—C₆H₅; and
R14 is H, OH, a halogen atom, an alkyl, an alkyl-oxy or an alkenyl group, preferably R14 is H.
   Examples of compounds of general formula (VI) include, but are not limited to:

| Compound | Structure |
|---|---|
| 1 | 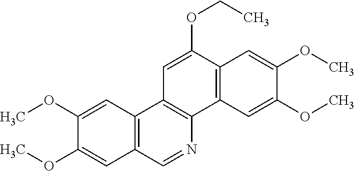 |
| 2 | 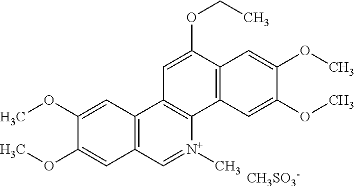 |
| 3 | 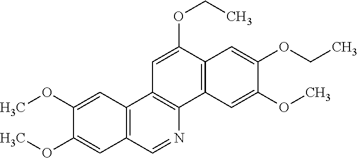 [SMILES: CCOc1cc2c(OCC)cc3c4cc(OC)c(OC)cc4cnc3c2cc1OC] |
| 4 | 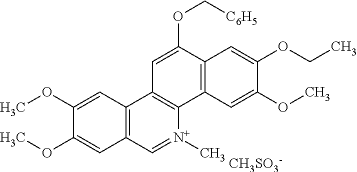 |
| Chelerythrine | 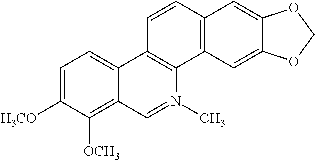 [SMILES: COc1ccc2c(c[n+](C)c3c4cc5c(cc4ccc23)OCO5)c1OC] |
| Sanguinarine | 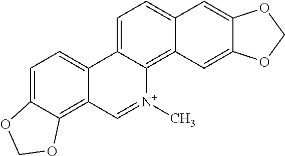 [SMILES: C[n+]1cc2c3c(ccc2c2ccc4cc5c(cc4c21)OCO5)OCO3] |

In one embodiment, the at least one PKc inhibitor is selected from the group consisting of compound 1, compound 2, compound 3, compound 4, chelerythrine, sanguinarine; and Cl⁻, HSO₄⁻, I⁻ or HCO₃⁻ salts thereof, and mixtures thereof.

In one embodiment, the at least one PKc inhibitor is selected from chelerythrine, sanguinarine; and Cl⁻, HSO₄⁻, I⁻, HCO₃⁻ salts thereof. In one embodiment, the at least one PKc inhibitor is a mixture of chelerythrine and sanguinarine. In one embodiment, the at least one PKc inhibitor is a mixture of Cl⁻, HSO₄⁻, I⁻, HCO₃⁻ salts of sanguinarine and chelerythrine.

In one embodiment, the at least one PKc inhibitor is assessed for its anti-fungal effects as well as comprised in the compositions of the invention in a purified form comprising substantially exclusively such potentiating agent (at least 85% w/w or at least 90% w/w, in weight relative to the at least one PKc inhibitor composition).

In one embodiment, the at least one PKc inhibitor is comprised in the compositions of the invention in the form of a plant extract comprising at least 20% w/w of chelerythrine, sanguinarine; and Cl⁻, HSO₄⁻, I⁻, HCO₃⁻ salts thereof, in weight relative to the dry weight of the extract. In one embodiment, the extract comprising the at least one PKc inhibitor is an extract of a plant selected from Macleaya cordata, Chelidonium majus, Agremone mexicana or Sanguinaria canadensis.

In one embodiment, such extract is an aqueous extract, an hydroalcoholic extract, an ethanolic extract, a methanolic extract, an ethyl acetate extract or a supercritical CO₂ extract.

In one embodiment, the extract is a crude extract, without subsequent fractionation of the extracted compounds.

In one embodiment, the extract is an enriched extract, preferably an alkaloid-enriched extract or fraction. Numerous techniques are known in the art for obtaining such enriched extract such as for example, liquid-liquid extraction/partitioning or adsorption/absorption chromatography.

In one particular embodiment, the at least one PKc inhibitor is a Macleaya cordata extract. Preferably such extract comprises at least 30% w/w or at least 40% w/w of sanguinarine, in weight relative to the dry extract weight.

In one embodiment, the molar ratio of sanguinarine/chelerythrine is such extract ranges from 2 to 4, from 2.5 to 3.5 or is about 2.8.

In one embodiment, the compound of general formula (V) is such that R6 and R7 together form a ring, preferably a substituted ring, more preferably a bi-cycle. According to this embodiment, the at least one PKc inhibitor of a plant defense molecule may be a compound of general formula (VII)

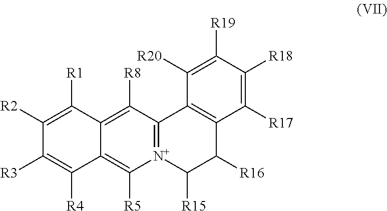

wherein:
R1 is H, OH, an alkyl, an alkyl-oxy, a halogen atom or an alkenyl group, preferably R1 is H;
R2, R3 and R4 are such that:
   R2 and R3 together form a ring comprising 5 or 6 atoms, preferably a heterocycle comprising 5 or 6 atoms, more preferably a dioxolane and R4 is H, OH, an alkyl, an alkyl-oxy, a halogen atom or an alkenyl group, preferably R4 is H; or
   R3 and R4 together form a ring comprising 5 or 6 atoms, preferably a heterocycle comprising 5 or 6 atoms, more preferably a dioxolane and R2 is H, OH, an alkyl, an alkyl-oxy, a halogen atom or an alkenyl group, preferably R2 is H; or
   each of R2, R3 and R4 independently is H, OH, an alkyl, an alkyl-oxy, a halogen atom or an alkenyl group;
each of R5, R15 and R16 independently is H, OH, an alkyl, an alkyl-oxy, a halogen atom or an alkenyl group, preferably each of R5, R15 and R16 is H;
R17 is H, OH, an alkyl, an alkyl-oxy, a halogen atom or an alkenyl group, preferably R17 is H or methyl-oxy;
R18 and R19 are such that
   R18 is H, OH, an alkyl, an alkyl-oxy, a halogen atom or an alkenyl group, preferably R18 is methyl-oxy; and R19 is H, OH, an alkyl, an alkyl-oxy, a halogen atom or an alkenyl group, preferably R19 is H; or
   R18 and R19 together form a ring comprising 5 or 6 atoms, preferably a heterocycle comprising 5 or 6 atoms, more preferably a dioxolane; and
R20 is H, OH, an alkyl, an alkyl-oxy, a halogen atom or an alkenyl group, preferably R20 is H.
   In one embodiment, the counterion may be selected from the group comprising Cl⁻, CH₃SO₃⁻, HSO₄⁻, I⁻, HCO₃⁻, BF₄⁻ or PF₆⁻.
   Examples of compounds of general formula (VII) include, but are not limited to,

| Compound | Structure |
|---|---|
| Coptisine | 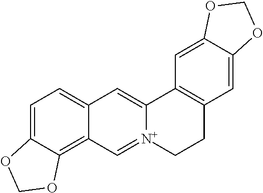 [SMILES: c1c2c(cc3c1OCO3)-c1cc3ccc4c(c3c[n+]1CC2)OCO4] |
| Berberine | 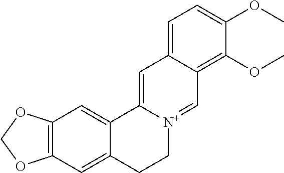 [SMILES: COc1ccc2cc3[n+](cc2c1OC)CCc1cc2c(cc1-3)OCO2] |

Advantageously, the at least one PKc inhibitor is in an in vitro sub-effective, typically non-fungicidal amount. The methods for determining the in vitro sub-effective amount of the at least one UPR inhibitor are also applicable for determining the in vitro sub-effective amount of the at least one PKc inhibitor. In one embodiment, the in vitro sub-effective amount of least one PKc inhibitor is in a concentration equal or inferior to a non-fungicidal concentration C2; wherein the non-fungicidal concentration C2 is determined by comparing the growth of the phytopathogenic fungal strain cultures in contact with increasing concentrations of said at least one PKc inhibitor, with the growth of a control culture of the phytopathogenic fungal strain, in the absence of said at least one PKc inhibitor; the last concentration of the increasing concentrations of the at least one PKc inhibitor resulting in the same fungal culture growth as the control culture being retained as the non-fungicidal concentration C2 of said at least one PKc inhibitor.

In one specific embodiment, the sub-effective, typically the non-fungicidal amount of the at least one PKc inhibitor ranges from about 1 nM to about 100 μM or from about 1 nM to about 50 μM.

In one embodiment, the sub-effective, typically the non-fungicidal amount of the at least one PKc inhibitor ranges from about 1 μM to about 150 μM, preferably from about 5 μM to about 70 μM, more preferably from about 5 to about 50 μM or from about 1 to about 10 μM.

In one embodiment, when the amount of the at least one PKc inhibitor is reported to chelerythrine the sub-effective, typically the non-fungicidal amount of said least one PKc inhibitor ranges from more than 0 μM to about 70 μM, from more than 0 μM to about 40 μM, or from more than 0 μM to about 30 μM.

In one embodiment, when the amount of the at least one PKc inhibitor is reported to sanguinarine the sub-effective, typically the non-fungicidal amount of said least one PKc inhibitor ranges from more than 0 p M to about 150 μM, from more than 0 μM to about 80 μM, from more than 0 μM to about 75 μM, or from more than 0 μM to about 50 μM.

In one embodiment, the method further comprises applying at least one agent for stimulating the production of a plant defense molecule such as, for example, a phytoalexin, by a plant organ. In one embodiment, the at least one at least one agent for stimulating the production of a plant defense molecule is applied simultaneously or sequentially to the composition comprising at least one UPR inhibitor. In one embodiment, when the agent for stimulating the production of a plant defense molecule is applied simultaneously with the composition comprising at least one UPR inhibitor, the composition of the invention comprises the at least one UPR inhibitor and further comprises said the at least one at least one agent for stimulating the production of a plant defense molecule.

In one embodiment, said agent for stimulating the production of a plant defense molecule is present in the composition in a sub-effective, typically a non-fungicidal amount. Preferably, said non-fungicidal amount is determined as previously detailed above. The methods for determining the in vitro sub-effective amount of the at least one UPR inhibitor are also applicable for determining the in vitro sub-effective amount of the at least one agent for stimulating the production of a plant defense molecule. In one embodiment, the in vitro sub-effective amount of least one agent for stimulating the production of a plant defense molecule is in a concentration equal or inferior to a non-fungicidal concentration C3; wherein the non-fungicidal concentration C3 is determined by comparing the growth of the phytopathogenic fungal strain cultures in contact with increasing concentrations of said at least one agent for stimulating the production of a plant defense molecule, with the growth of a control culture of the phytopathogenic fungal strain, in the absence of said at least one agent for stimulating the production of a plant defense molecule; the last concentration of the increasing concentrations of the at least one agent for stimulating the production of a plant defense molecule resulting in the same fungal culture growth as the control culture being retained as the non-fungicidal concentration C3 of said at least one agent for stimulating the production of a plant defense molecule.

In one embodiment, the agent for stimulating the production of a plant defense molecule is selected from acibenzolar-S-methyl (benzothiadiazole) (such as for example BION 50 WGR or DACONIL ACTION®), chitosan (such as for example BIOREND® KITOZYM®, CHARGE®, ChiProPant® or KITAE®), laminarin (such as for example VACCIPLANT® or IODUS®), a plant extract such as Reynoutria Sachalinensis extract (such as for example REGALIA®), calcium prohexadione (such as for example APOGEE® or REGALIS®), harpine (such as for example PROACT®), yeast wall extracts such as cerevisane (such as for example ROMEO® or ACTILEAF®), COS-OGA (Chito-oligosaccharides in association with Oligo-galacturonides, such as for example FYTOSAVE® or MESSAGER® or MESSIDOR® or GALOPIN+® or BASTIDR or BLASON® or ESDEAINE®), oligogalacturonides, dissodium or calcium or potassium phosphonates (such as for example CERAXEL® or SIRIUS® or REDELI® or ETONAN® or FRUCTIAL® or SDN TOP® or SORIALE® or PERTINAN® or MIFOS or LBG-01F34®), 24-Epibrassinolide, ABE-IT56 (Yeast Extract), Heptamaloxyloglucan, Pepino mosaic virus strain CH2 isolate 1906 and Pythium oligandrum strain B301, Micropeptides (≤100 amino acids), amino acids, living microorganisms and microorganisms extract (such as lysate of amibes Willaertia magna C2c Maky).

In one particular embodiment, the composition further comprises at least one phytopharmaceutical antifungal agent. In one embodiment, the at least one phytopharmaceutical antifungal agent is synthetic or mineral fungistatic or fungicide phytopharmaceutical agent. The at least one phytopharmaceutical antifungal agent may be selected from the list consisting of 2-(dithiocyanomethylthio)-benzothiazol, 2,5-Dichlorobenzoic acid methylester, 2-Aminobutane (aka sec-butylamine), 2-Benzyl-4-chlorophenol, 2-Phenylphenol (incl. sodium salt orthophenyl phenol), 4-Chloro-3-methylphenol, 5-chloro-3-methyl-4-nitro-1H-pyrazole (CMNP), 8-Hydroxyquinoline incl. oxyquinoleine, Aldimorph, Alkyltrimethyl ammonium chloride, Ametoctradin, Amisulbrom, Ammonium carbonate, Ammonium hydroxyde, Ampelomyces quisqualis strain AQ10, Ampropylfos, Anilazine, Aspergillus flavus strain MUCL 54911, Aureobasidium pullulans (strains DSM 14940 and DSM 14941), Azaconazole, Azoxystrobin, Bacillus amyloliquefaciens (formerly subtilis) str. QST 713, Bacillus amyloliquefaciens FZB42, Bacillus amyloliquefaciens MBI 600, Bacillus amyloliquefaciens strain FZB24, Bacillus amyloliquefaciens subsp. plantarum D747, Bacillus nakamurai F727, Bacillus pumilus QST 2808, Barium polysulphide, Benalaxyl, Benalaxyl-M, Benodanil, Benomyl, Bentaluron, Benthiavalicarb, Benzoic acid, Benzovindiflupyr, Bis(tributyltin) oxide, Bitertanol, Bixafen, Blasticidin-S, Bordeaux mixture, Boscalid (formerly nicobifen), Brandol (hydroxynonyl-2,6-dinitrobenzene), Bromuconazole, Bronopol, Bupirimate, Calcium chloride, Calcium propionate, Candida oleophila strain O, Captan, Carbendazim, Carboxin, Carpropamide, Chinomethionat (aka quinomethionate), Chlobenthiazone, Chlorhydrate of poly(iminino imido biguanidine), Chlorine dioxide, Chloroneb, Chlorophylline, Chlorothalonil, Chlozolinate, Choline Phosphonate, Clonostachys rosea strain J1446 (Gliocladium catenulatum strain J1446), Coniothyrium minitans Strain CON/M/91-08 (DSM 9660), Copper hydroxide, Copper oxide, Copper oxychloride, Cresylic acid, Cufraneb, Cyazofamid, Cyflufenamid, Cymoxanil, Cyproconazole, Cyprodinil, Cyprofuram, Dazomet, Dichlofluanid, Dichlone, Dichlorophen, Diclobutrazol, Dicloran, Didecyldimethylammonium chloride, Diethofencarb, Difenoconazole, Dimethirimol, Dimethomorph, Dimethyl disulphide, Dimoxystrobin, Diniconazole-M, Dinobuton, Dinocap, Dioctyldimethyl ammonium chloride, Disodium phosphonate, Ditalimfos, Dithianon, DNOC, Dodemorph, Dodine, Drazoxolon, Epoxiconazole, Etaconazole, Ethaboxam, Ethirimol, Ethylhexanoate, Etridiazole, Eugenol, Extract from tea tree, Famoxadone, Fenamidone, Fenaminosulf, Fenarimol, Fenbuconazole, Fenfuram, Fenhexamid, Fenpiclonil, Fenpropidin, Fenpropimorph, Fenpyrazamine, Fentin acetate, Fentin hydroxide, Ferbam, florylpicoxamid, Fluazinam, Fludioxonil, Fluopicolide, Fluopyram, Fluoxapiprolin, Fluoxastrobin, Fluquinconazole, Flusilazole, Flusulfamide, Flutianil, Flutolanil, Flutriafol, Fluxapyroxad, Folpet, Formaldehyde, Fosetyl, Fuberidazole, Furalaxyl, Furconazole, Furmecyclox, Geraniol, Glutaraldehyde (aka glutardialdehyde), Guazatine, Hexachlorophene, Hexaconazole, Hydroxyphenyl-salicylamide, Hymexazol, Imazalil (aka enilconazole), Imibenconazole, Iminoctadine, Iprobenfos, Iprodione, Iprovalicarb, Isofetamid, Isoprothiolane, Isopyrazam, Isotianil, Kasugamycin, Kresoxim-methyl, L-Ascorbic acid, Lauryldimethylbenzylammonium bromide, Lecithin, Lime sulphur (calcium polysulphid), Lysate of Willaertia magna C2c Maky, Mancopper, Mancozeb, Mandestrobin, Mandipropamid, Maneb, Mepanipyrim, Mepronil, Meptyldinocap, Metalaxyl, Metalaxyl-M, Metam (incl. -potassium and -sodium), Metconazole, Methfuroxam, Methyl bromide, Methyl isothiocyanate, Methylenebisthiocyanate, Metiram, Metominostrobin, Metrafenone, Metsulfovax, Myclobutanil, Nabam, Nitrothal, Nonylphenol ethoxylate, Nuarimol, Octhilinone, Octyldecyldimethyl ammonium chloride, Ofurace, OptiCHOS, Orysastrobin, Oxadixyl, Oxine-copper, Oxpoconazole, Oxycarboxin, Pefurazoate, Penconazole, Pencycuron, Penflufen, Penthiopyrad, Petroleum oils, Picoxystrobin, Piperalin, Plant oils/Clove oil, Polyoxin, Potassium iodide, Potassium permanganate, Potassium phosphonates (formerly potassium phosphite), Potassium sorbate, Potassium thiocyanate, Potassium tri-iodide, Probenazole, Prochloraz, Procymidone, Propamocarb, Propiconazole, Propineb, Propionic acid, Proquinazid, Prothiocarb, Prothioconazole, Pseudomonas chlororaphis strain MA342, Pseudozyma flocculosa, Pyraclostrobin, Pyrazophos, Pyrifenox, Pyrimethanil, Pyriofenone, Pyroquilon, Pythium oligandrum M1, Quinoxyfen, Quintozene, Reynoutria sacchalinensis extract, Saccharomyces cerevisiae strain LAS02, Sedaxane, Silthiofam, Silver nitrate, Simeconazole, Sodium arsenite, Sodium dichlorophenate, Sodium dimethyldithiocarbamate, Sodium hydrogen carbonate (basic substance), Sodium lauryl sulfate, Sodium metabisulphite, Sodium o-benzyl-p-chlorphenoxide, Sodium propionate, Sodium p-t-amylphenate, Sodium p-t-amylphenoxide, Sodium tetrathiocarbonate, Spiroxamine, Streptomyces K61 (formerly S. griseoviridis), Streptomyces lydicus WYEC 108, Sulphur, TCMTB, Tebuconazole, Tecnazene, Tetraconazole, Thiabendazole, Thiophanate (ethyl), Thiophanate-methyl, Thiram, Thymol, Tiadinil, Tolclofos-methyl, Tolylfluanid, Triadimefon, Triadimenol, Triazbutyl, Triazoxide, Tribasic copper sulfate, Trichoderma asperellum (formerly T. harzianum) strains ICC012, T25 and TV1, Trichoderma asperellum strain T34, Trichoderma atroviride (formerly T. harzianum) strain T11 and IMI 206040, Trichoderma atroviride strain I-1237, Trichoderma atroviride strain SC1, Trichoderma gamsii (formerly T. viride) strain ICC080, Trichoderma harzianum B97, Trichoderma polysporum strain IMI 206039, Tricyclazole, Tridemorph, Trifloxystrobin, Triflumizole, Triforine, Trioxymethylen, Triticonazole, Validamycin, Valifenalate (formerly Valiphenal), Verticillium albo-atrum (formerly Verticillium dahliae) strain WCS850, Vinclozolin, Yucca schidigera extract, Zineb, Ziram, Zoxamide, Zucchini yellow mosaic virus-weak strain, Zucchini yellow mosaic virus (ZYMV mild strain), or a combination thereof.

In one particular embodiment, the composition further comprises at least one phytopharmaceutical antifungal agent against Botrytis strains, typically selected from the list consisting of Aureobasidium pullulans (strains DSM 14940 and DSM 14941), Aqueous extract from the germinated seeds of sweet Lupinus albus, Azoxystrobin, Bacillus amyloliquefaciens (formerly subtilis) str. QST 713, Bacillus amyloliquefaciens MBI 600, Bacillus amyloliquefaciens strain FZB24, Bacillus amyloliquefaciens subsp. plantarum D747, Boscalid (formerly nicobifen), Clonostachys rosea strain J1446 (Gliocladium catenulatum strain J1446), Cyprodinil, Difenoconazole, Eugenol, Fenhexamid, Fenpyrazamine, Fluazinam, Fludioxonil, Fluopyram, Fluxapyroxad, Geraniol, Imazalil (aka enilconazole), Isofetamid, Mepanipyrim, Metconazole, Metschnikowia fructicola strain NRRL Y-27328, Penthiopyrad, Potassium hydrogen carbonate, Pyrimethanil, Saccharomyces cerevisiae strain LAS02, Tebuconazole, Thymol, Trichoderma atroviride strain SC1, and Trifloxystrobin.

In one particular embodiment, the applied composition further comprises a plant defense molecule selected from brassinin, camalexin, resveratrol, 3,5-dihydroxybiphenyl, aucuparin, ε-viniferin and 6-methoxymellein.

Alternatively or additionally, the composition may further comprise an insecticide and/or an herbicide, as generally known in the art.

According to a first variant, the method for treating is a method for preventing, controlling and/or treating a fungal infection by a phytopathogenic fungal strain on a plant organ. In one embodiment, the method is for controlling and/or treating a fungal infection by a phytopathogenic fungal strain on a plant organ.

According to a second variant, the method for treating is a method for reducing the incidence a phytopathogenic infection meaning the decrease of the number on infected plant organs in a plant culture. In one embodiment, the method of the invention is for reducing the severity of a phytopathogenic infection, meaning the decrease of the percentage of the infected surface (i.e. decolorized or necrotic surface) relative to the total plant organ surface.

According to a third variant, the method for treating is a method for improving the growing characteristics of a plant organ The characteristics of a plant organ may be selected from the yield and/or vigour of the plant and/or the quality of the harvested product from the plant, or the root rating, or emergence, or protein content, or increased tillering, or bigger leaf blade, or less dead basal leaves, or stronger tillers, or less fertilizer needed, or less seeds needed, or more productive tillers, or earlier flowering, or early grain maturity, or less plant verse (lodging), or increased shoot growth, or earlier germination, or any combination of these factors, or any other advantages familiar to a person skilled in the art.

According to a fourth variant, the method for treating is a method for enhancing the efficacy and/or reducing the amount of a phytopharmaceutical antifungal agent and/or of an agent for stimulating the production of a plant defense molecule in a method for preventing, controlling or treating a fungal infection by a phytopathogenic fungal strain. According to such variant, the antifungal active agent and/or the agent for stimulating the production of a plant defense molecule may be selected from the lists detailed herein above. According to such variant, enhancing the efficacy may lead to a decrease of at least about 5%, or at least about 10% in the number/percentage of infected plant organs in the plant culture treated with the method of the invention, compared to the number/percentage of infected plant organs in a plant culture treated with the phytotherapeutically effective amount of the phytopharmaceutical antifungal agent alone.

One skilled in the art knows the phytopharmaceutically effective amount of one phytopharmaceutical antifungal agent or an agent for stimulating the production of a plant defense molecule which is often established by regulatory provisions. In one embodiment, preferably an embodiment of the fourth variant, the phytopharmaceutical antifungal agent is applied in a reduced amount that is a phytopharmaceutically sub-effective amount, which is at least 2%, at least 5%, at least 8%, at least 10%, at least 12%, at least 15%, at least 18%, at least 20%, at least 22%, at least 25%, at least 28%, or at least 30% inferior to the phytopharmaceutically effective amount of the antifungal agent or the agent for stimulating the production of a plant defense molecule.

In the context of the present invention “phytopathogenic fungi” or “phytopathogenic fungal strain(s)” refers to at least one fungal pathogen for plant organs (at least one phytopathogenic fungal strain). In one embodiment, the least one phytopathogenic fungal strain may be a biotroph, which depends on living tissue for feeding. In one embodiment, the least one phytopathogenic fungal strain may be hemibiotroph, which requires living tissue, but kills the host plant at some stage. In one embodiment, the least one phytopathogenic fungal strain may be necrotroph, which feeds on dead plant tissue.

Examples of phytopathogenic fungi include, but are not limited to, fungi belonging to the Ascomycetes and Basidiomycetes classes, such as, for example, fungi of the order of Erysiphales (such as, for example, family Erysiphaceae, genera Uncinula, Erysiphe, Sphaerotheca); fungi of the order of Dothideales (such as, for example, family Venturiaceae genus Venturia); fungi of the order of Helotiales (such as, for example, family Sclerotiniaceae, genera Sclerotinia, Monilia/Monilinia, Botrytis/Botryotinia); fungi of the order of Taphrinales (such as, for example, family Taphrinaceae, genus Taphrina); fungi of the order of Pleosporales (such as, for example, family Pleosporaceae, genus Alternaria); fungi of the order of Magnaporthales (such as, for example, family Magnaportaceae genus Magnaporthe-Pyricularia); fungi of the order Mycosphaerellaceae (such as for example fungi of the families Sclerotinia, Mycosphaerella and Zymoseptoria); fungi of the order of Hypocreales (such as, for example, family Nectriaceae, genus Fusarium); fungi of the order of Uredinales (such as, for example, family Pucciniaceae, genus Puccinia); and fungi of the order of Ustilaginales (such as, for example, family Ustilaginaceae, genus Ustilago).

According to a preferred embodiment, the at least one phytopathogenic fungal strain is selected from fungi of the order of Erysiphales further selected from the genera Uncinula, Erysiphe, Sphaerotheca; fungi of the order of Dothideales further selected from the genus Venturia; fungi of the order of Helotiales further selected from the genera Sclerotinia, Monilia/Monilinia, Botrytis/Botryotinia; fungi of the family Pleosporaceae, preferably further selected from the genus Alternaria; fungi of the order Mycosphaerellaceae further selected from the families Sclerotinia, Mycosphaerella and Zymoseptoria.

In one embodiment, the at least one phytopathogenic fungal strain is selected from the genera Alternaria, Fusarium, Botrytis or Botryotinia, Sclerotinia, Dreschlera, Venturia, Hyaloperonospora, Plasmodiophora, Phoma, Erysiphe, Rhizoctonia, Pythium, Cercospora, Podosphaera, Gymnosporangium, Pythopthora, Plasmopara, Uncinula, Guignardia, Eutypa, Phomopsis, Botryosphaeria, Zymospetoria, Puccinia, Blumeria, Oculimacula, Gaeumannomyces, Pyrenophora, Phakospora, Septoria, Peronospora, Colletotrichum, Microsphaera, Corynespora, Helminthosporium, Pyricularia, Rhizoctonia, Sarocladium, Erythricium, Mycospharella, Urocystis, Monilinia, Taphrina, Cladosporium, Cytospora, Phomopsis, Cercosporidium, Phoma and Leptosphaerulina, preferably the at least one phytopathogenic fungal strain is selected from the genera Alternaria, Botrytis, Venturia, Erysiphe and Zymospetoria.

In one specific embodiment, the at least one pathogenic fungus is selected from the genera Alternaria and/or Botrytis. In one specific embodiment, the at least one pathogenic fungus is selected from the group comprising Alternaria brassicicola and/or Botrytis cinerea.

Plant organs throughout their evolution have developed inherent mechanisms of defense against phytopathogenic infections. In particular, plant organs are inherently capable of expressing plant defense molecules, against infections by phytopathogenic fungi. For example, plant defense molecules can be selected from phenolic compounds such as phenolic acids such as coumarins, flavonoids, biphenyls, and stilbenes; terpenes further selected from sequiterpenoids, diterpenoids, and triterpenoids; sulfur-containing molecules; and alcaloids.

In one embodiment, the plant organ inherently expresses at least one defense molecule selected from sulfur-containing molecules, stilbenes, flavonoids such as isoflavoid derivatives, in particular pterocarpanes, diterpenoids, triterpenoids, sesquiterpenoids and phenolic compounds further selected from biphenyls, naphthalenes and coumarins. In one embodiment, the plant defense molecules are selected from sulfur-containing molecules such as brassinin or allicin, stilbenes further selected from resveratrol and ε-viniferin, flavonoids such as isoflavoid derivatives, in particular pterocarpanes such as glyceolines, diterpenoids such as phytocassanes, momilactones and oryzalexins; triterpenoids, such as ellarinacin; sesquiterpenoids such as rishitin; and phenolic phytoalexins such as biphenyls further selected from such as 3,5-dihydroxybiphenyl, aucuparin and/or phloretin; naphthalenes and coumarins such as 6-methoxymellein. According to one exemplary embodiment of the invention, the plant organ to be treated inherently expresses at least one defense molecule selected from brassinin, stilbenes further selected from resveratrol and 8-viniferin, and triterpenes, in particular ellarinacin and biphenyls further selected from phenolic phytoalexins such as 3,5-dihydroxybiphenyl, aucuparin and/or phloretin.

The plant organ to be treated according to the present method can be a plant organ of the plants selected from the list comprising plants of the Brassicacae family, such as, for example, Brassica oleracea; plants of the Apiaceae family, such as, for example, Daucus carota subsp. Sativus; plants of the Vitaceae family, such as, for example, Vitis vinifera; plants of the Rosaceae family, such as, for example, apple (Malus domestica), pears (Pyrus comunis), Prunus spp., in particular plums, cherries, peaches, nectarines, apricots, and almonds, plants of the Solanaceae family, such as, for example Solanum tuberosum or Solanum lycopersicum, plants of the Poaceae family, such as, for example wheat (Triticum spp.) or rice (Oryza spp., Zizania spp. and Porteresia spp), plants of the Fabaceae family, such as soy (Glycine max) or peanuts (Arachis hypogaea), plants of the Musaceae family such as bananas (Musa spp), plants of the Alliaceae family, such as such as onion (Allium cepa) or garlic (Allium sativum), plants of the Rutaceae family, such as orange, citrus, lemon and grapefruit and plants of the Sterculiaceae family such as cacao tree. Preferably the plant organ is plant organ of the plants selected from the list comprising plants of the Brassicacae family, such as, for example, Brassica oleracea; plants of the Apiaceae family, such as, for example, Daucus carota subsp. Sativus; plants of the Vitaceae family, such as, for example, Vitis vinifera; plants of the Rosaceae family, such as, for example, apple (Malus domestica), pear (Pyrus comunis), Prunus spp., in particular plums, cherries, peaches, nectarines, apricots, and almonds, and plants of the Poaceae family, such as, for example wheat (Triticum spp.).

In one preferred embodiment, the plant organ is a plant organ of a Rosaceae plant species such as Malus domestica (apple tree) or Pyrus communis (pear tree), inherently expressing plant defense phenolic molecules, typically biphenyls such as 3,5-dihydroxybiphenyl, aucuparin and/or phloretin, and the at least one pathogenic fungus is selected from the species selected from the group consisting of Venturia inaequalis, Podosphaera leucotricha, Gymnosporangium clavipes, and Phytophthora spp., preferably Venturia inaequalis.

In one preferred embodiment, the plant organ is a plant organ of a Vitaceae plant species such as Vitis vinifera (common grape vine) inherently expressing plant defense stilbene molecules, such as resveratrol or ε-viniferin, and the at least one pathogenic fungus is selected from the species selected from the group consisting of Erysiphe spp Plasmopara viticola, Uncinula necator, Botryotinia fuckelina (Botrytis cinerea), Guignardia bidwellii, Eutypa dieback, Phomopsis dieback, Botryosphaeria dieback and the esca complex, preferably the at least one pathogenic fungus is Erysiphe necator.

In one preferred embodiment, the plant organ is a plant organ of wheat species such as Triticum aestivum (Poaceae family) inherently expressing plant defense molecules typically selected from flavonoids, diterpenes, and triterpenes, such as ellarinacin and the at least one pathogenic fungus is selected from the species selected from the group consisting of Fusarium culmorum and F. graminearum, Zymoseptoria tritici and Septoria nodorum, Puccinia graminis, Puccina striiformis, Puccinia recondita, Blumeria graminis, Oculimacula yallundae, Oculimacula acuformis, Gaeumannomyces graminis var. tritici, Pyrenophora tritici-repentis (telomorph) and Drechslera tritici-repentis (anamorph), preferably the at least one pathogenic fungus is Zymoseptoria tritici.

In one embodiment, the plant organ is a plant organ of a Solanaceae plant species such as Solanum tuberosum (potato) or Solanum lycopersicum (tomato) inherently expressing plant defense molecules typically selected from sequiterpenoids, such as rishitin and the at least one pathogenic fungus is selected from the species selected from the group consisting of Botrytis cinerea, Phytophthora infestans, Alternaria alternata, Erysiphae cichoracearum, and Alternaria solani.

In one exemplary embodiment, the plant organ is a plant organ of an Apiaceae plant species such as Daucus carotta (carrot plant) inherently expressing plant defense molecules typically selected from phenolic compounds, in particular coumarins such as 6-methoxymellein, and the at least one pathogenic fungus is selected from the species selected from the group consisting of Alternaria dauci, Rhizoctonia spp, Pythium spp., Cercospora spp, Erysiphe spp, preferably Alternaria dauci.

In one embodiment, the plant organ is a plant organ of a leguminous plants (Fabaceae family) such as soy (Glycine max) inherently expressing plant defense molecules typically selected from flavonoids, in particular isoflavonoids and derivatives thereof, in particular prenylated isoflavonoids such as glyceolins, and the at least one pathogenic fungus is selected from the species selected from the group consisting of Phakopsora pachyrhizi, Septoria glycines (teleomorph Mycosphaerella uspenskajae), Peronospora manshurica (synonym P. sojae), Cercospora sojina, Cercospora kikuchii., Alternaria spp, Colletotrichum truncatum and C. destructivum (teleomorph Glomerella glycines), Microsphaera diffusa (synonyms: Erysiphe polygoni and E. glycines), Corynespora cassiicola (synonyms: Cercospora melonis, C. vignicola, Helminthosporium vignae, and H. vignicola).

In one embodiment, the plant organ is a plant organ of a Poaceae family plants such as rice (Oryza spp., Zizania spp. and Porteresia spp.) inherently expressing plant defense molecules typically selected from diterpenes, such as phytocassanes, momilactones and oryzalexins, and the at least one pathogenic fungus is selected from the species selected from the group consisting of Pyricularia oryzae (Teleomorph stage Magnaporthe oryzae), Deuteromycetes spp., Drechslera oryzae (Synonym Cochliobolus miyabeanus—anamorph: Bipolaris oryzae), Sclerotium oryzae, Rhizoctonia solani, Sarocladium oryzae, and Fusarium moniliforme.

In one embodiment, the plant organ is a plant organ of a cacao tree (Theobroma cacao) and the at least one pathogenic fungus is selected from the species selected from the group consisting of Phytophthora capsici, Phytophthora citrophthora, Phytophthora hevae, Phytophthora megakarya, Phytophthora palmivora, Erythricium salmonicolor, and Colletotrichum spp.

In one embodiment, the plant organ is a plant organ of a banana plant (Musa spp.) inherently expressing plant defense molecules typically selected from phenolic compounds, in particular naphthalenes such as anigofurone, and the at least one pathogenic fungus is selected from the species selected from the group consisting of Mycospharella musicola, Mycospharella fifiensis, Fusarium oxysporum, Colletotrichum musae, Verticillium theobromae, and Trachyspaera fructigena.

In one embodiment, the plant organ is a plant organ of an Alliaceae family plant such as onion (Allium cepa) or garlic (Allium sativum) inherently expressing plant defense molecules typically selected from sulfur-containing molecules such as allicin, and the at least one pathogenic fungus is selected from the species selected from the group consisting of Peronospora destructor, Botrytis squamosa, Botrytis allii and Urocystis cepulac.

In one embodiment, the plant organ is a plant organ of a drupaceous (stone fruit) plant such as almond, apricot, cherry, damson, peach, nectarine, and plum, and the at least one pathogenic fungus is selected from the species selected from the group consisting of Monilinia fructicola, Taphrina deformans, Cladosporium carpophilum, Cytospora cincta and C. leucostoma.

In one embodiment, the plant organ is a plant organ of a Rutaceae family plant (such as orange, citrus, lemon and grapefruit) and the at least one pathogenic fungus is selected from the species selected from the group consisting of Mycosphaerella citri, Phomopsis citri, and Phytophthora spp.

In one embodiment, the plant organ is a plant organ of peanut (Arachis hypogaea) and the at least one pathogenic fungus is selected from the species selected from the group consisting of Cercosporidium personatum, Cercospora arachidicola, Phoma arachidicola, and Leptosphaerulina crassiasca.

In one embodiment, the plant organ is a plant organ of a plant selected from the list consisting of apple, azalea, begonia, columbine, crabapple, crape myrtle, dogwood, euonymus, grape, hydrangea, lilac, magnolia, nandina, oak, phlox, rhododendron, rose, sedum, tulip tree, verbena, zinnia and the at least one pathogenic fungus is selected from the species, causing powdery mildiew (such as Podosphaera spp. Erysiphe spp. Uncinula spp or Microsphaera spp.).

In one embodiment, the plant organ is a plant organ of a plant selected from Alyssum, basil, brambles, coleus, grape, garden impatiens, pansy, and the at least one pathogenic fungus is selected from the species, causing downy mildiew (such as Phytophthora infestans, Plasmopara spp. or Peronospora spp.).

In one embodiment, the plant organ is a plant organ of a plant selected from apple, aster, azalea, cedar, crabapple, daylily, fuchsia, geranium, grasses, hawthorn, hemlock, hollyhock, iris, Jack-in-the-pulpit, juniper, mayapple, morning glory, oak, pear, pine, potentilla, quince, serviceberry, snapdragon, sunflower, and the at least one pathogenic fungus is selected from the species, causing rust (such as Gymnosporangium nfestans spp. Puccinia spp. or Phakospora spp).

In one embodiment, the plant organ is a plant organ of a plant selected from Aucuba, impatiens, marigold, zinnia; Boxwood, sweet box, pachysandra; Magnolia, maple; Buckeye, crape myrtle, hydrangea, leucothoe, laurel, phlox, red bud, rose, zinnia; Indian hawthorn, pear, photina, cleyera; Holly, magnolia, maple, witch hazel; Dogwood, and the at least one pathogenic fungus is selected from the species, causing leaf spot disease such as Alternaria leaf spot, Boxwood blight, bull's eye leaf spot, Cercospora leaf spot, Entomosporium leaf spot, Phyllosticta leaf spot, or Septoria leaf spot.

In one embodiment, the plant organ is a plant organ of a plant selected from Scots pine, Eastern white pine; Loblolly pine; Spruce; Juniper; juniper, Leyland cypress; Austrian pine, and the at least one pathogenic fungus is selected from the species, causing Needle Cast and/or Tip Blights diseases such as Cyclaneusma needle cast, Lophodermium needle cast, Ploioderma needle cast, Rhizosphaera needle cast and Stigmina needle cast Phomopsis blight, kabatina blight, or Dothistroma blight.

In one specific embodiment, the fungal strains belonging to the genus Alternaria are selected from Alternaria alternata, A. alternantherae, A. arborescens, A. arbusti, A. blumeae, A. brassicae, A. brassicicola, A. burnsii, A. carotiincultae, A. carthami, A. celosiae, A. cinerariae, A. citri, A. conjuncta, A. cucumerina, A. dauci, A. dianthi, A. dianthicola, A. eichhorniae, A. euphorbiicola, A. gaisen, A. helianthi, A. helianthicola, A. hungarica, A. infectoria, A. japonica, A. limicola, A. linicola, A. longipes, A. molesta, A. panax, A. perpunctulata, A. petroselini, A. porri, A. radicina, A. raphani, A. saponariae, A. selini, A. senecionis, A. solani, A. smyrnii, A. tenuissima, A. triticina and A. zinnia.

In one specific embodiment, the at least one pathogenic fungus is selected from the group comprising Alternaria brassicicola, Botrytis cinerea, Alternatria dauci and Venturia inaequalis.

In one specific embodiment, the phytopathogenic fungi are pathogens of plants belonging to the clade of Angiosperms, preferably to the clade of Eudicots, more preferably to the clade of Rosids, even more preferably to the order of Brassicales and even more preferably to the family of Brassicacae, also referred as Crucifers family. Examples of plants from the Brassicacae family include, but are not limited to, Brassica carinata, Brassica juncea, Brassica oleracea, Brassica napus, Brassica nigra and Brassica rapa.

In one specific embodiment, the phytopathogenic fungi are pathogens of plants selected from the list comprising plants of the Brassicacae family, such as, for example, Brassica oleracea; plants of the Apiaceae family, such as, for example, Daucus carota subsp. Sativus; plants of the Vitaceae family, such as, for example, Vitis vinifera; plants of the Rosaceae family, such as, for example, apple (Malus domestica), pears (Pyrus comunis), Prunus spp., in particular plums, cherries, peaches, nectarines, apricots, and almonds, plants of the Solanaceae family, such as, for example Solanum tuberosum or Solanum lycopersicum, plants of the Poaceae family, such as, for example wheat (Triticum spp.) or rice (Oryza spp., Zizania spp. and Porteresia spp), plants of the Fabaceae family, such as soy (Glycine max).

In one specific embodiment, the phytopathogenic fungi are pathogens of plants selected from the list comprising plants of the Brassicacae family, such as, for example, Brassica oleracea; plants of the Apiaceae family, such as, for example, Daucus carota subsp. Sativus; plants of the Vitaceae family, such as, for example, Vitis vinifera; or plants of the Rosaceae family, such as, for example, apple (Malus domestica), pears (Pyrus comunis).

In one specific embodiment, plant organ is a plant organ of the plants selected from the list comprising plants of the Brassicacae family, such as, for example, Brassica oleracea; plants of the Apiaceae family, such as, for example, Daucus carota subsp. Sativus; plants of the Vitaceae family, such as, for example, Vitis vinifera; plants of the Rosaceae family, such as, for example, apple (Malus domestica), pears (Pyrus comunis), Prunus spp., in particular plums, cherries, peaches, nectarines, apricots, and almonds, plants of the Solanaceae family, such as, for example Solanum tuberosum or Solanum lycopersicum, plants of the Poaceae family, such as, for example wheat (Triticum spp.) or rice (Oryza spp., Zizania spp. and Porteresia spp), plants of the Fabaceae family, such as soy (Glycine max) or peanuts (Arachis hypogaea), plants of the Musaceae family such as bananas (Musa spp), plants of the Alliaceae family, such as such as onion (Allium cepa) or garlic (Allium sativum), plants of the Rutaceae family, such as orange, citrus, lemon and grapefruit and plants of the Sterculiaceae family such as cacao tree; and

the at least one pathogenic fungus is selected from the genera Alternaria, Fusarium, Botrytis or Botryotinia, Sclerotinia, Dreschlera, Venturia, Hyaloperonospora, Plasmodiophora, Phoma, Erysiphe, Rhizoctonia, Pythium, Cercospora, Podosphaera, Gymnosporangium, Pythopthora, Plasmopara, Uncinula, Guignardia, Eutypa, Phomopsis, Botryosphaeria, Zymospetoria, Puccinia, Blumeria, Oculimacula, Gaeumannomyces, Pyrenophora, Phakospora, Septoria, Peronospora, Colletotrichum, Microsphaera, Corynespora, Helminthosporium, Pyricularia, Rhizoctonia, Sarocladium, Erythricium, Mycospharella, Urocystis, Monilinia, Taphrina, Cladosporium, Cytospora, Phomopsis, Cercosporidium, Phoma and Leptosphaerulina.

In one specific embodiment, the plant organ is a plant organ of the plants selected from the group consisting of Brassica oleracea, Daucus carota subsp. Sativus; Vitis vinifera; Malus domestica, Pyrus comunis, Prunus spp., in particular plums, cherries, peaches, nectarines, apricots, and almonds, and Triticum spp., preferably selected from the list consisting of the plants Brassica oleracea, Vitis vinifera; Malus domestica, and Triticum spp; said organ inherently expressing at least one plant defense molecule as, typically selected from brassinin resveratrol, 8-viniferin, ellarinacin; 3,5-dihydroxybiphenyl, aucuparin and/or phloretin; naphthalenes and 6-methoxymellein; preferably selected from brassinin resveratrol, ε-viniferin, ellarinacin; 3,5-dihydroxybiphenyl, aucuparin, and phloretin; and the at least one phytopathogenic fungal strain is selected from the genera Alternaria, Botrytis, Venturia, Erysiphe and Zymospetoria, preferably selected from Alternaria brassiciola, Botrytis cinerea, Venturia inequalis, Erysiphe necator and Zymospetoria trittici.

In one specific embodiment, the plant organ is a plant organ of the plants selected from the list comprising plants of Brassicacae, Apiaceae, Vitaceae, Rosaceae, Solanaceae, Fabaceae, Poaceae, Musaceae, Alliaceae, Rutaceae and Sterculiaceae families, preferably the plant organ is plant organ of the plants selected from the list consisting of plants of the Brassicacae family, plants of the Apiaceae family, plants of the Vitaceae family, plants of the Rosaceae family and plants of the Poaceae family, even more preferably the plant organ is plant organ of the plants selected from the list consisting of plants of the Brassicacae family, plants of the Apiaceae family, plants of the Vitaceae family, plants of the Rosaceae family and plants of the Poaceae family;

said organ inherently expressing at least one plant defense molecule, typically selected from sulfur-containing molecules such as brassinin or allicin, stilbenes further selected from resveratrol and ε-viniferin, flavonoids such as isoflavoid derivatives, in particular pterocarpanes such as glyceolines, diterpenoids such as phytocassanes, momilactones and oryzalexins; triterpenoids, such as ellarinacin; sesquiterpenoids such as rishitin; and phenolic phytoalexins such as biphenyls further selected from such as 3,5-dihydroxybiphenyl, aucuparin and/or phloretin; naphthalenes such as anigofurone and coumarins such as 6-methoxymellein; and

the at least one pathogenic fungus is selected from the group consisting of fungi of the order of Erysiphales further selected from the genera Uncinula, Erysiphe, Sphaerotheca; fungi of the order of Dothideales further selected from the genus Venturia); fungi of the order of Helotiales further selected from the genera Sclerotinia, Monilia/Monilinia, Botrytis/Botryotinia; fungi of the family Pleosporaceae, preferably further selected from the genus Alternaria; fungi of the order Mycosphaerellaceae further selected from the families Sclerotinia, Mycosphaerella and Zymoseptoria; preferably the at least one phytopathogenic fungus is selected from the group consisting of the genera Alternaria, Fusarium, Botrytis or Botryotinia, Sclerotinia, Dreschlera, Venturia, Hyaloperonospora, Plasmodiophora, Phoma, Erysiphe, Rhizoctonia, Pythium, Cercospora, Podosphaera, Gymnosporangium, Pythopthora, Plasmopara, Uncinula, Guignardia, Eutypa, Phomopsis, Botryosphaeria, Zymospetoria, Puccinia, Blumeria, Oculimacula, Gaeumannomyces, Pyrenophora, Phakospora, Septoria, Peronospora, Colletotrichum, Microsphaera, Corynespora, Helminthosporium, Pyricularia, Rhizoctonia, Sarocladium, Erythricium, Mycospharella, Urocystis, Monilinia, Taphrina, Cladosporium, Cytospora, Phomopsis, Cercosporidium, Phoma and Leptosphaerulina, more preferably the at least one phytopathogenic fungal strain is selected from the genera Alternaria, Botrytis, Sclerotinia, Venturia, Erysiphe and Zymospetoria.

According to a second aspect, the invention relates to a composition, typically a phytopharmaceutical composition, comprising at least one UPR inhibitor as described in any one of the above embodiments in association with at least one phytopharmaceutical vehicle. In a preferred embodiment, the at least one UPR inhibitor is selected from the group consisting of γ-mangostin, 1,3,5 trihydroxy-4-prenylxanthone, 1,3,5 trihydroxy-2-prenylxanthone and a mixture thereof, preferably the at least one UPR inhibitor being γ-mangostin; said at least one UPR inhibitor being in a sub-effective amount being a concentration according to any one of the above embodiments, preferably ranging from 5 μM to 500 μM, more preferably from 30 μM to 200 μM, more preferably from 30 μM to 100 μM, even more preferably from 35 μM to 75 μM.

In one embodiment, the at least one UPR inhibitor is pure γ-mangostin such as for example at least 95% w/w, preferably at least 97% w/w, more preferably 99% w/w, still more preferably 100% w/w γ-mangostin in weight of the total UPR inhibitor weight. According to a variant, the at least one UPR inhibitor does not comprises α-mangostin. According to a variant, the phytopharmaceutical composition does not comprises α-mangostin. In one embodiment, the pure γ-mangostin is of synthetic origin or fractionated and purified γ-mangostin.

In one embodiment, the phytopharmaceutical composition further comprises at least one PKc inhibitor as described above, preferably selected from the group consisting of chelerythrin, sanguinarin, berberin, coptisin and a mixture thereof and/or at least one agent for stimulating the synthesis of a plant defense molecule as described above, preferably said agent being selected from the group consisting of acibenzolar-S-methyl, chitosan, laminarin, Reynoutria sachalinensis extract, calcium prohexadione, harpine, yeast wall extracts, oligogalacturonides, calcium phosphonate, disodium phosphonate and a mixture thereof. The invention, further relates to the use of the phytopharmaceutical composition for preventing, controlling or treating a fungal infection by a phytopathogenic fungal strain, typically at least one phytopathogenic fungal strain as described above, on a plant organ, typically of a plant as described above.

According to a third aspect, the invention relates to a kit-of-parts comprising:
A first part comprising a composition comprising at least one UPR inhibitor as described in any one of the above embodiments,
A second part comprising the at least one phytopharmaceutical vehicle, and optionally
A third part comprising a composition comprising at least one PKc inhibitor as described above, and further optionally
A fourth part comprising a composition comprising an agent for stimulating the production of a plant defense molecule as described above.

### BRIEF DESCRIPTION OF THE DRAWINGS

FIG. 1: FIG. 1A is a graph showing the inhibitory effect of DISA1 (3,5-diiodosalicylaldehyde) in the growth of Alternaria brassicicola. FIG. 1B is a graph showing the inhibitory effect of DISA1 (3,5-diiodosalicylaldehyde) in the growth of Botrytis cinerea. The abscissa illustrates the assessed DISA1 concentrations. The ordinate illustrates the percentage of the fungal growth

FIG. 2: FIG. 2A is a graph showing the inhibitory effect of γ-mangostin in the growth of Alternaria brassicicola. FIG. 2B is a graph showing the inhibitory effect of γ-mangostin in the growth of Botrytis cinerea. The abscissa illustrates the assessed DISA1 concentrations. The ordinate illustrates the percentage of the fungal growth.

FIG. 3: FIG. 3A is a graph showing the inhibitory effect of 1,3,5 trihydroxy-2-prenylxanthone in the growth of Alternaria brassicicola. FIG. 3B is a graph showing the inhibitory effect of 1,3,5 trihydroxy-2-prenylxanthone in the growth of Botrytis cinerea. The abscissa illustrates the assessed 1,3,5 trihydroxy-2-prenylxanthone concentrations. The ordinate illustrates the percentage of the fungal growth.

FIG. 4: FIG. 4A is a graph showing the inhibitory effect of 1,3,5 trihydroxy-4-prenylxanthone in the growth of Alternaria brassicicola. FIG. 4B is a graph showing the inhibitory effect of 1,3,5 trihydroxy-4-prenylxanthone in the growth of Botrytis cinerea. The abscissa illustrates the assessed 1,3,5 trihydroxy-4-prenylxanthone concentrations. The ordinate illustrates the percentage of the fungal growth.

FIG. 5 is a graph combined with pictures illustrating the in planta effect of the invention against A. brassicicola. The graph (below) shows the necrotic areas in cm² by A. brassicicola (Abra43, controls) compared with in the necrotic areas in cm² in the presence of an inhibitor of the UPR pathway: (Abra43+3) γ-mangostin (5 μM), (Abra43+4) 1,3,5-trihydroxy-2-prenylxanthone (50 μM), (Abra43+5) 1,3,5-trihydroxy-4-prenylxanthone (10 μM) and Abra43+DISA1 (2.5 μM). *, **, *** Indicate the significant difference with a p-value <0.05, <0.01, <0.001 respectively, obtained by the Wilcoxon test with paired data. °, °°, °°° Indicate the significant difference with a p-value <0.05, <0.01, <0.001 respectively, obtained by the Wilcoxon test with the unpaired data. The photographs (FIG. 5, above) visually illustrate the comparison of the necrotic areas by A brassicicola (Abra43) the presence (right side of the leaf's central nerve) or not (control, left side of the leaf's central nerve) of an inhibitor of the UPR pathway as detailed in the graph.

FIG. 6 is a graph combined with pictures illustrating the in planta effect of the invention against B. cinerea. The graph (below) shows the necrotic areas in cm² by B. cinerea (B05.10, controls) compared with in the necrotic areas in cm² in the presence of an inhibitor of the UPR pathway: (B05.10+3) γ-mangostin (5 μM), (B05.10+4) 1,3,5-trihydroxy-2-prenylxanthone (50 μM), (B05.10+5) 1,3,5-trihydroxy-4-prenylxanthone (10 μM) and B05.10+DISA1 (2.5 μM). *, **, *** Indicate the significant difference with a p-value <0.05, <0.01, <0.001 respectively, obtained by the Wilcoxon test with paired data. °, °°, °°° Indicate the significant difference with a p-value <0.05, <0.01, <0.001 respectively, obtained by the Wilcoxon test with the unpaired data. The photographs (FIG. 6, above) visually illustrate the comparison of the necrotic areas by B. cinerea (B05.10) the presence (right side of the leaf's central nerve) or not (control, left side of the leaf's central nerve) of an inhibitor of the UPR pathway as detailed in the graph.

FIG. 7: is a graph showing in vitro the inhibitory effect of ε-viniferin (1: ε-V, 100 μM), γ-mangostin (2: γM, 100 μM) and their combination (1+2) in the growth of Botrytis cinerea after 35 hours of incubation. The abscissa illustrates the above assessed conditions. The ordinate illustrates the percentage of the fungal growth inhibition.

FIG. 8: is a graph showing the in vitro inhibitory effect of negative control (T, DMSO), ε-viniferin (1: ε-V, 100 μM), γ-mangostin (2: γM, 100 μM) and their combination (1+2) in the growth of Botrytis cinerea during 35 hours of incubation. The abscissa presents time (hours). The ordinate illustrates the measured Nephelometric Turbity Units.

FIG. 9: is a graph representing the average foliar discs area affected by the powdery mildew (Erysiphe necator) following a treatment with water (control) or a phytopharmaceutical composition containing γ-mangostin in a non-fungicidal amount (75 μM).

FIG. 10: is a graph representing the average apple leaves' area affected by apple scab (Venturia inaequalis) following a treatment with water (control) or a phytopharmaceutical composition containing γ-mangostin in a non-fungicidal amount (75 μM).

FIG. 11: is a graph representing the average wheat plant leaves' area affected by Septoria leaf blotch (Zymoseptoria tritici) following a treatment with water (control) or a phytopharmaceutical composition containing γ-mangostin in a non-fungicidal amount (75 μM).

### EXAMPLES

The present invention is further illustrated by the following examples.

### Example 1: IRE1 Inhibitors Screening

A series of natural products were screened for their capacity to inhibit the UPR pathway via the inhibition of IRE1 in an in vitro screening test, based inhibition of the transcriptional activator HAC1 in Saccharomyces cerevisiae (the IRE1 protein is the ‘sole effector of the UPR pathway in fungi).

Table 1 presenting the results of the in vitro screening test

| | | | μ (% |
|---|---|---|---|
| Compound Class | N° CAS | Compound | activation) ± σ |
| benzyltetrahydro | 481-49-2 | Cepharantine | 102.2 ± 4.0 |
| isoquinoleines | 436-05-5 | (-)-Curine | 100.0 ± 3.8 |
| | 518-94-5 | Cycleanine | 102.2 ± 1.9 |
| Benzophen- | 34316-15-9 | Chelerythrine | 103.2 ± 3.6 |
| anthridines | 2447-54-3 | Sanguinarine | 91.1 ± 3.1 |
| Cularines | 87035-67-4 | Claviculine | 100.3 ± 2.5 |
| Pavines | 6901-16-2 | (−)-Argemonine | 102.6 ± 2.0 |
| | 5876-16-4 | (−)-Norargemonine | 101.7 ± 3.6 |
| Oxoaporphines | 58262-58-1 | Oxostephanine | 77.5 ± 0.9 |
| Protoberberines | 130-86-9 | Protopine | 99.0 ± 3.1 |
| | 17132-69-3 | Steponine | 103.4 ± 1.3 |
| | 84-39-9 | Stylopine | 101.4 ± 4.1 |
| | 2934-97-6 | Tétrahydropalmatine | 101.8 ± 4.8 |
| | 81701-50-0 | (±)-8- | 99.6 ± 2.8 |
| | | Oxotetrahydropalmatine | |
| Quinolizidines | 151757-06-1 | Anibacanine | 100.2 ± 3.6 |
| | 151851-38-6 | Pseudoanibacanine | 100.0 ± 3.7 |
| Diterpenes | 139628-86-7 | (−)-monomethylester-15 | 103.8 ± 1.1 |
| | | dehydropinifolic acid | |
| Sequiterpene | 35730-78-0 | Cynaropicrin | 105.6 ± 0.7 |
| lactones | 20554-84-1 | Parthenolide | 105.3 ± 1.1 |
| Triterpenes | 514-47-6 | Euphol | 105.3 ± 0.7 |
| | 559-74-0 | Friedelin | 104.6 ± 0.7 |
| | 227008-51-7 | (20R,23E)-Eupha-8,23- | 100.6 ± 2.5 |
| | | diene-3b,25-diol | |
| Triterpene lactones | 3649-76-1 | Ebelin lactone | 102.5 ± 0.9 |
| Terpenic Acids | 138-59-0 | Shikimic acid | 102.0 ± 6.2 |
| Phenolic Acids | 530-57-4 | Syringic acid | 97.8 ± 3.1 |
| Anthocyanes | 490-46-0 | Epicatechin | 101.4 ± 0.4 |
| Anthraquinones | 518-82-1 | Emodin | 104.5 ± 3.1 |
| Benzoquinones | 777862-54-1 | Tetraprenyltoluquinone | 100.8 ± 1.5 |
| | 490-91-5 | Thymoquinone | 104.3 ± 2.2 |
| Biflavonoids | 1617-53-4 | Amentoflavone | 101.8 ± 2.3 |
| | 27542-37-6 | (±)-Volkensiflavone | 95.8 ± 0.5 |
| Chalcone | 94530-80-0 | (±)-Lindératine | 103.0 ± 2.1 |
| Coumarins | 7380-40-7 | Bergamotine | 103.5 ± 1.6 |
| | 30563-62-3 | Mammea A/AA cycloF | 93.8 ± 1.1 |
| | 54947-82-9 | Mammea A/AC | 102.4 ± 1.7 |
| | 93-35-6 | Umbelliferone | 105.3 ± 2.3 |
| | 2107-76-8 | 5,7-dihydroxy-4-methyl | 104.0 ± 1.4 |
| | | coumarin | |
| Dihydrochalcone | 60-82-2 | Phloretin | 101.8 ± 1.7 |
| Cinnamic esters | 107843-77-6 | Benzyl caffeate | 104.6 ± 4.8 |
| | 115610-79-2 | Cinnamyl caffeate | 73.4 ± 1.7 |
| | 100884-13-7 | Prenyl caffeate | 102.4 ± 0.8 |
| Flavonoïds | 480-40-0 | Chrysine | 91.7 ± 1.4 |
| | 548-82-3 | Pinobanksine | 101.5 ± 0.8 |
| | 480-41-1 | Naringenin | 101.1 ± 1.2 |
| | 52117-69-8 | Pinobanksine 3-O-acetate | 100.3 ± 2.7 |
| | 117-39-5 | Quercetin | 98.5 ± 1.4 |
| | 522-12-3 | Quercitrin | 102 ± 2.4 |
| | 14221-65-9 | 3,5-dihydroxy-6,7,8- | 98.3 ± 2.4 |
| | | trimethoxyflavone | |
| Lignans | 35354-74-6 | Honokiol | 93.9 ± 2 |
| | 40456-50-6 | Yatein | 100.7 ± 2.5 |
| Naphtoquinone | 481-39-0 | Juglone | 43.5 ± 3.7 |
| Polyphenol | 458-37-7 | Curcumine | 177.3 ± 10.3 |
| PPAP | 900501-08-8 | N-(3-Phenyl-n-propyl)-1- | 102.6 ± 1 |
| | | phenyl-2-aminopropane | |
| Proanthocyanidols | 29106-49-8 | Procyanidin B2 | 101.6 ± 1 |
| Xanthones | 439293-37-5 | Caledonixanthone K | 100.7 ± 2 |
| | 105037-93-2 | Calothwaitesixanthone | 104.6 ± 1.4 |
| | 155566-36-2 | Caloxanthone C | 104.2 ± 2.8 |
| | 112649-21-5 | Garcinon E | 101.6 ± 3.9 |
| | 33390-42-0 | Gartanin | 95.1 ± 5.5 |
| | 219649-95-3 | Griffipavixanthone | 96.8 ± 1.3 |
| | 199851-52-0 | Isocudraniaxanthone B | 94.3 ± 0.9 |
| | 55785-61-0 | Thwaitesixanthone | 101.1 ± 2.1 |
| | 6147-11-1. | α-mangostin | 67.5 ± 0.2 |
| | 20931-37-7 | β-mangostin | 100.3 ± 4.7 |
| | 31271-07-5 | γ-mangostin | 8.7 ± 5.5 |
| | 16302-46-8 | 1-methoxy-2-hydroxy- | 97.9 ± 3.6 |
| | | xanthone | |
| | 53377-61-0 | 1,3,5-trihydroxy-4- | 70.9 ± 3.2 |
| | | prenylxanthone | |
| | 20245-38-9 | 1,3,5-trihydroxy-2- | 57.4 ± 4.9 |
| | | prenylxanthone | |
| | 20245-39-0 | 1,3,7-trihydroxy-2- | 89.7 ± 0.6 |
| | | prenylxanthone | |
| | 5084-31-1 | 1,3,5,6-tétra-hydroxy- | 103.9 ± 0.7 |
| | | xanthone | |
| | 77182-02-6 | 2-Deprenyl- | 97.3 ± 4.2 |
| | | rheediaxanthone B | |
| | 129168-62-3 | 2,5,6,7,8- | 102.3 ± 0.7 |
| | | Pentahydroxyxanthone | |
| | 181307-40-4 | 5-O-methyl-2- | 91.6 ± 3.3 |
| | | deprenylrheediaxanthone | |
| | | B | |
| | 181307-38-0 | 5,6-O-dimethyl-2- | 100.3 ± 1.6 |
| | | deprenylrheediaxanthone | |
| | 33390-41-9 | 8-deoxygartanin | 96.6 ± 5.7 |
| | 35349-68-9 | 9-hydroxycalabaxanthone | 103.5 ± 2.8 |

Compounds leading to an IRE1 activity of less than 80% were retained as IRE1 inhibitors.

Juglone, cinnamyl caffeate, γ-mangostin, 1,3,5 trihydroxy-4-prenylxanthone, and 1,3,5 trihydroxy-2-prenylxanthone were found to inhibit IRE1 in a micromolar scale. DISA1 (3,5-diiodosalicylaldehyde, CAS N°2631-77-8), a well reported IRE1 inhibitor, was used as a positive control showing an IRE1 IC₅₀ of 2.6 μM.

Of interest γ-mangostin showed an IRE1 IC₅₀ of 7.3 μM, 1,3,5 trihydroxy-4-prenylxanthone showed an IRE1 IC₅₀ of 12.8 μM, juglone showed an IRE1 IC₅₀ of 12.8 μM and cinnamyl caffeate showed an IRE1 IC₅₀ of 21.6 μM. Lastly, demethylrubraxanthone was also found a to inhibit IRE1 (IC₅₀: 6.5±0.4 μM).

Based on the above results, the capacity of a crude extract of Garcinia mangostana was assessed for its capacity to inhibit IRE1. Crushed Garcinia mangostana pericarps were twice extracted with a mixture of Ethyl Acetate:Ethanol (78:22, volume ratio) in a ultrasound bath at 20° C., yielding 12.5 g of a dry G. mangostana crude extract. The average extraction yield was 12.5 g of crude extract per 100 g of Crushed Garcinia mangostana pericarps. The thin layer chromatography analysis of the crude extract indicated the presence of γ-mangostin, that was confirmed by NMR spectrometry

100 mg/L of the Garcinia mangostana pericarp crude extract lead a more than 90% inhibition of IRE1 (IC₅₀: 14.1±1.8 mg/L). The amount of γ-mangostin in said extract was 25 μM.

### Example 2: Determination of the in Vitro Non-Fungicidal Concentration

### Materials and Methods

For inoculum preparation, conidia of A. brassicicola or B. cinerea were collected from solid culture by adding water followed by gentle scraping of the agar plate. They were then counted in a Thoma's chamber and the conidial suspension was diluted to a final concentration of 106 conidia/mL in water. A volume of 100 μL of conidia suspension was added in 890 μL of PDB medium and completed with 10 μL of the compound prepared in DMSO. Concentrations of the assessed compounds varied from 0.1 μM to 100 μM. 300 μL of treated conidia were added in triplicate in each well of Greiner® 96-well PS, F-Bottom, clear sterile microplate. Growth was monitored by nephelometric reader (NEPHELOstar Galaxy®, BMG Labtech, Offenburg, Germany) at 25° C., with orbital shaking 5 min before measurement for 33 h. Turbidity was registered every 10 mins with a gain value of 75. Each well was measured during 0.1 s with a laser beam focus of 2.5 mm. A triplicate was realized for each condition. Area under the growth curve was determined by an Excel matrix developed in the lab. Area under the growth curve was normalized by area of positive control (filamentous fungi+DMSO less compound) and PDB medium to obtain a growth percentage.

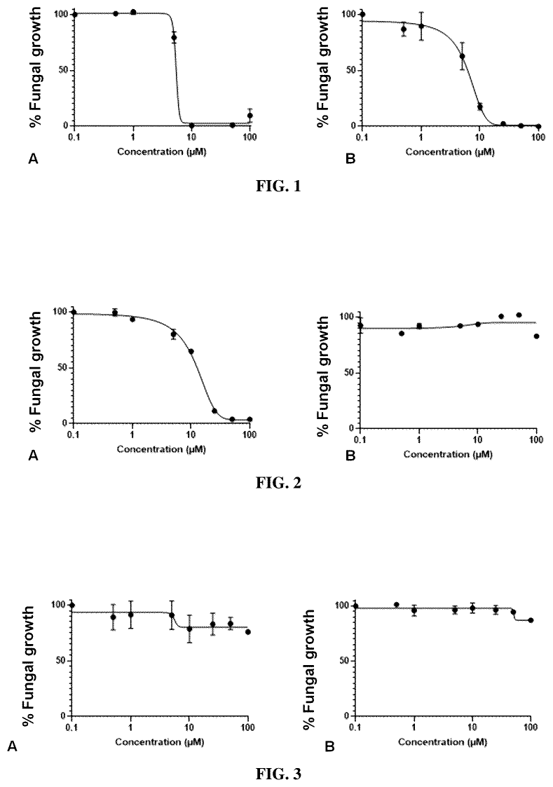

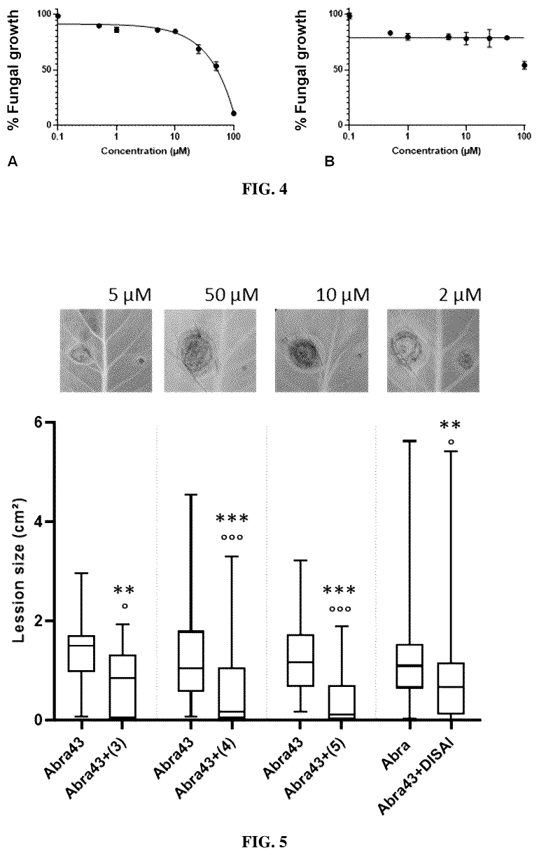

The results are presented in FIGS. 1-4.

### Example 3: In Planta Effect of a Non-Fungicidal Amount of the Compound According to the Invention

Example 3 discloses a protocol for determining the in planta efficacy of the composition of the invention, comprising a non-fungicidal amount of xanthones (C_{TP}), as determined in Example 2.

Based on the Example 2 results, the concentrations inducing a 50% inhibition of the fungal growth (MIG₅₀), the concentrations inducing at most 20% inhibition of the fungal growth (Cₘₐₓ) were calculated and presented in table 2. The retains non-fungicidal concentrations (C_{TP}) that were applied in planta were inferior to the MIG₅₀ and inferior or equal to the Cₘₐₓ concentrations

Table 2 presenting the MIG₅₀, Cₘₐₓ and CTP values of the in planta assessed compounds.

| | A. brassicicola | | | | | | B. cinerea | | | | | |
|---|---|---|---|---|---|---|---|---|---|---|---|---|
| Compound | MIG₅₀ | | C_{TP} | | Cₘₐₓ | | MIG₅₀ | | C_{TP} | | Cₘₐₓ | |
| DISAl | 5.3 ± 0.1 | μM | 2 | μM | 2 | μM | 6.3 ± 0.7 | μM | 2.5 | μM | 2.5 | μM |
| γ-mangostin, | 12.2 ± 0.2 | μM | 5 | μM | 5 | μM | >>100 | μM | 25 | μM | 100 | μM |
| 1,3,5 | >>100 | μM | 50 | μM | 100 | μM | >>100 | μM | 25 | μM | 100 | μM |
| trihydroxy-2- | | | | | | | | | | | | |
| prenylxanthone | | | | | | | | | | | | |
| 1,3,5 | 41.3 ± 3.7 | μM | 10 | μM | 10 | μM | >>100 | μM | 25 | μM | 100 | μM |
| trihydroxy-4- | | | | | | | | | | | | |
| prenylxanthone | | | | | | | | | | | | |

5 μL drops of A. brassicicola or B. cinerea conidia suspension (10⁵ to 10³ conidia/mL) were inoculated on prewounded (i.e wherein the synthesis of plant defense molecules such as Brassinin was naturally triggered by the aggression) leaves of B. oleracea cv Bartolo plants at stages 4-6 leaves per plant. Inocula were deposited on the left and right sides symmetrically from the central vein: inocula comprising C_{TP} concentration the assessed compounds were deposited on the right side, and inocula comprising DMSO (negative control) were deposited on the left side. The plants were then maintained under saturated humidity (100% relative humidity). Symptoms were observed at day 6 post-infection. The necrotic surface area was calculated and compared between the left side (control) and right side (test condition) of the central vein.

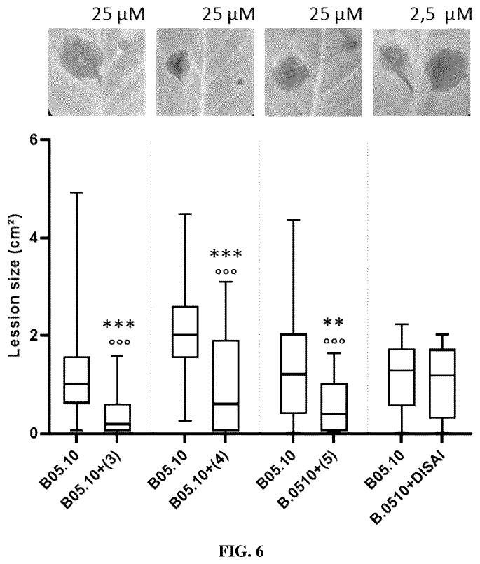

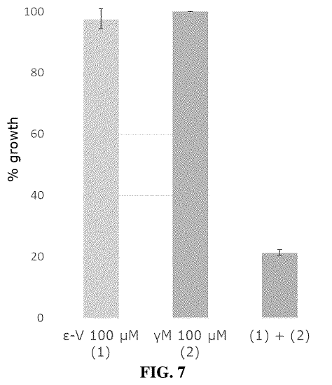

The results are presented in FIG. 5 and FIG. 6 and in table 3. The significance of the measured efficacy was assessed with Wilcoxon's test.

Table 3 presenting the in planta test results.

| | Wilcoxon′s Test | | | |
|---|---|---|---|---|
| | Linked data | | Unlinked data | |
| | n. of | p- | n. of | p- |
| A. brassicicola | leaves | values | leaves | values |
| Control vs γ-mangostin (5 μM) | 16 | 0.0062 | 16 | 0.0288 |
| Control vs 1,3,5 trihydroxy-2- | 34 | 2.3.10⁻⁵ | 34 | 0.0003 |
| prenylxanthone (50 μM) | | | | |
| Control vs 1,3,5 trihydroxy-4- | 22 | 0.0002 | 23 | 4.8.10⁻⁵ |
| prenylxanthone (10 μM) | | | | |
| Control vs DISA1 (2 μM) | 30 | 0.0012 | 31 | 0.0198 |
| | n. of | p- | n. of | p- |
| B. cinerea | leaves | values | leaves | values |
| Control vs γ-mangostin (25 μM) | 26 | 8.2.10⁻⁵ | 27/28 | 5.8.10⁻⁶ |
| Control vs 1,3,5 trihydroxy-2- | 37 | 2.2.10⁻⁵ | 37/38 | 1.1.10⁻⁵ |
| prenylxanthone (25 μM) | | | | |
| Control vs 1,3,5 trihydroxy-4- | 28 | 0.0089 | 31/29 | 0.0006 |
| prenylxanthone (25 μM) | | | | |
| Control vs DISA1 | 19 | 0.7086 | 22/21 | 0.5882 |

The results show that although at C_{TP} concentration that is inferior or equal to a the Cₘₐₓ concentration, the compounds do not exert a fungicidal effect in vitro, they surprisingly exert an antifungal effect in planta due to a potentiating effect of the plant's defense mechanisms.

### Example 4: In Vitro Effect of a Non-Fungicidal Amount of the Compound According to the Invention

The anti-fungal effect against B. cinerea of the plant defense molecule ε-viniferin (100 μM), γ-mangostin (100 μM) and their combination was assessed in vitro using the nephelometric protocol detailed in Example 2.

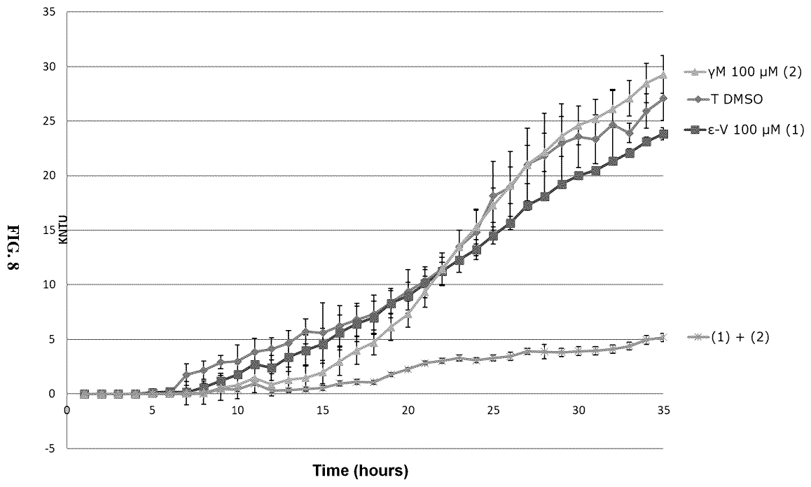

The results are presented in FIG. 7 and FIG. 8.

The results of Example 4 highlight the potentiating effect of γ-mangostin towards the antifungal effects of the plant defense molecule ε-viniferin.

### Example 5: Study of the Direct Biocide Effect of γ-Mangostin on Erysiphe necator (Grapevine Mildew)

Determination of the Non-Fungicidal Dose: Study of the Direct Biocide Effect of Gamma-Mangostin on Erysiphe necator

A qualitative method with 6 rates of a phytopharmaceutical composition based on mangosteen pericarp extract containing γ-mangostin was used to investigate the biocide effect of γ-mangostin on the fungus Erysiphe necator responsible for the powdery mildew of grapevine. The blank, corresponding to the vehicle of the phytopharmaceutical composition without the active substance, was also used as a control.

E. necator being an obligate parasite, which means that it needs to be on the plant to grow, it is not possible to use the protocol previously described using nephelometry as it implies that the fungus can grow in a liquid nutrient medium. Therefore, the “scotch” method was used to determine the direct biocide effect of the phytopharmaceutical composition on E. necator is described as follows:

The pathogen was grown on a grapevine leaf, the treatment was applied by spray and just after the conidia of E. necator are collected using an adhesive tape. The conidia were then observed using a microscope to determine their capacity to germinate and to form a germ tube. For each modality, the germination rate of the conidia was compared to the untreated control to calculate the percentage of inhibition (direct effect) and determine the maximum non-fungicidal concentration (<EC20).

TABLE 4
Germination rate of E. necator conidia and percentage of inhibition
achieved by the different treatments

| | Eq. | Germination | | |
|---|---|---|---|---|
| | γ-mangostin | (%) | SD | Inhibition (%) |
| Untreated | — | 95.60 | 1.67 | — |
| Blank | — | 84.20 | 5.45 | 11.92 |
| Mangosteen | 10 μM | 96.80 | 2.39 | 0.00 |
| pericarp | 25 μM | 94.20 | 2.59 | 1.46 |
| extract-based | 50 μM | 93.80 | 3.77 | 1.88 |
| composition | 75 μM | 88.20 | 3.11 | 7.74 |
| | 100 μM | 84.80 | 1.64 | 11.30 |
| | 150 μM | 80.80 | 3.90 | 15.48 |

The upper dose of the phytopharmaceutical composition tested achieved an inhibition on the germination of 20%, therefore the EC20 is not determinable and all concentrations below 150 μM of γ-mangostin could thus be considered as non-fungicidal on E. necator.

### Study of the Inhibition of Powdery Mildew on Foliar Discs

Treatment was made by spraying the mangosteen pericarp extract-based phytopharmaceutical composition at a concentration of γ-mangostin equivalent to 75 μM, or water (control), on the upper side of the Vitis vinifera leaf discs (2 replicates of 10 discs) that inherently express at least one plant defense molecule, in particular stilbenes such as resveratrol or ε-viniferin. The treatment was applied 3 days before infection (D-3). Inoculation was performed by dry deposition of conidia to achieve a density of 800 to 1000 spores per cm². Petri dishes are incubated in a climate chamber at 21±2° C. during 12 days. The intensity of the disease, corresponding to the surface of the foliar disc covered by mycelium of E. necator, a is then assessed for the two modalities. Results are presented in FIG. 9.

The application of a composition according to the invention, that is a non-fungicidal amount of γ-mangostin against powdery mildew (75 μM), induced a significant reduction of the foliar disks' affected area by powdery mildew (33% affected area) as opposed to the control foliar disks (73% affected area).

### Example 6: Study of the Direct Biocide Effect of γ-Mangostin on Venturia inaequalis (Apple Scab)

Determination of the Non-Fungicidal Dose: Study of the Direct Biocide Effect of Gamma-Mangostin on V. inaequalis

A plate test was used to evaluate the inhibitory effect of a phytopharmaceutical composition based on mangosteen pericarp extract containing γ-mangostin on the growth of Venturia inaequalis, the pathogenic fungus responsible of apple scab. This test is typically used when it is not possible to perform tests with a nephelometer, for example, to study a formulated product. 6 doses of the phytopharmaceutical formulation were tested with corresponding γ-mangostin concentrations ranging from 1 to 150 μM.

The nutrient medium composed of PDA is prepared and, except for the untreated control, the desired amount of the phytopharmaceutical formulation or the blank (co-formulants without active ingredient) is added during the melted phase. For each modality, the preparation is poured into four Petri dishes (4 replicates). Once the medium has cooled and solidified, a plug of mycelium of V. inaequalis from a collection maintained on a solid medium is placed in the center of each Petri dish. They are then placed in a climatic chamber with a specific temperature cycle allowing the optimal growth of the pathogenic fungus (20° C. day/16° C. night, 14 hours photoperiod). Two diameters of the radial mycelial growth of Venturia inaequalis are measured for each Petri dish after 21 days. The percentage of inhibition was calculated by comparing the average growth diameter of V. inaequalis of the corresponding treatment to that of the untreated control to determine the maximum non-fungicidal concentration (<EC20).

TABLE 5
Average growth diameter of V. inaequalis and percentage of
inhibition achieved by the different treatments

| | Eq. | Average growth | | Inhibition |
|---|---|---|---|---|
| | γ-mangostin | diameter (mm) | SD | (%) |
| Untreated | — | 11.87 | 1.31 | — |
| BLANK | — | 12.01 | 2.12 | 0.00 |
| Mangosteen | 10 μM | 12.87 | 1.25 | 0.00 |
| pericarp | 20 μM | 11.56 | 1.20 | 2.61 |
| extract- | 50 μM | 10.81 | 1.83 | 8.93 |
| based | 75 μM | 11.68 | 2.18 | 1.60 |
| composition | 100 μM | 9.75 | 0.57 | 17.86 |
| | 150 μM | 9.21 | 1.97 | 22.41 |

Considering the percentage of inhibition obtained for the different concentrations presented in Table 2, the EC20 of γ-mangostin in the phytopharmaceutical composition was found between 100 μM and 150 μM. Any concentration not exceeding 100 μM is therefore considered as non-fungicidal on V. inaequalis.

### Study of the Inhibition of Apple Scab in Planta

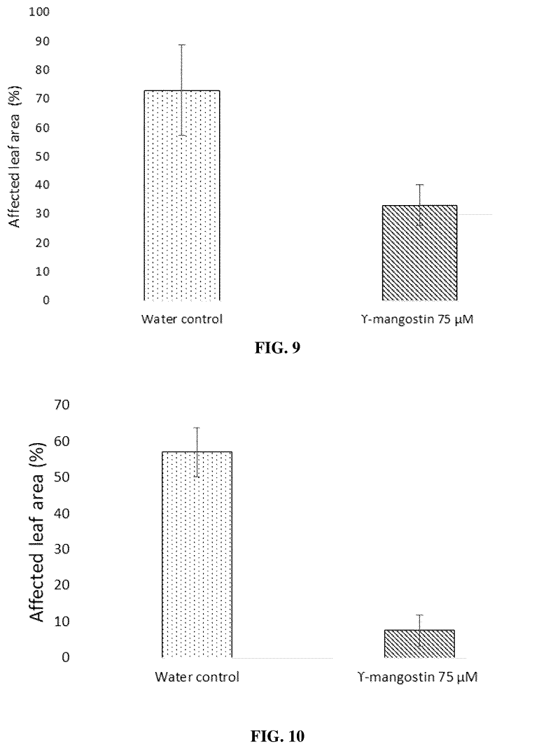

Treatment was made by spraying the mangosteen pericarp extract-based phytopharmaceutical composition at a concentration of γ-mangostin equivalent to 75 μM, or water (control), on leaves of young apple trees (10 trees per modality), that inherently express plant defense molecules, typically phenolic phytoalexins such as 3,5-dihydroxybiphenyl, aucuparin and/or phloretin. The treatment was applied twice, 7 days and 2 days before infection. Inoculation was carried out by spraying a suspension of conidia (150 000 conidia/mL) on the leaves. The treated apple trees were placed in a climatic chamber at 17° C. for 14 days. The intensity of the disease, corresponding to the percentage of the leaf area affected, was then assessed for the two modalities. Results are presented in FIG. 10.

The application of a composition according to the invention, that is a non-fungicidal amount of γ-mangostin against apple scab (75 μM), induced a significant reduction of the leaves' affected area by apple scab (7.56% affected area) as opposed to the control leaves (57.07% affected area).

### Example 7: Study of the Direct Biocide Effect of γ-Mangostin on Zymoseptoria tritici (Septoria Leaf Blotch of Wheat)

Determination of the Non-Fungicidal Dose: Study of the Direct Biocide Effect of Gamma-Mangostin on Z. tritici

A test in liquid nutrient medium was used to assess the direct effect of 6 doses of a phytopharmaceutical composition based on mangosteen pericarp extract containing γ-mangostin on Zymoseptoria tritici, the pathogenic fungus responsible for Septoria leaf blotch in wheat. A fungal spore suspension was prepared and mixed with the desired dose of the phytopharmaceutical composition or the blank, corresponding to the vehicle of the composition without the mangosteen pericarp extract. The different conditions were incubated at a suitable temperature for few hours. At the end of the incubation period, the growth of Z. tritici was assessed by measuring the length of pycnidiospores (30 for each treatment). The percentage of inhibition was determined by comparing the average length of pycnidiospores of each treated modalities to that of the untreated control.

TABLE 6
Average length of Z. tritici pycnidiospores and percentage of
inhibition achieved by the different treatments

| | Eq. | Average | | Inhibition |
|---|---|---|---|---|
| | γ-mangostin | length (μm) | SD | (%) |
| Untreated | — | 172.12 | 1.31 | — |
| BLANK | — | 168.25 | 2.12 | 2.25 |
| Mangosteen | 10 μM | 174.85 | 1.25 | 0.00 |
| pericarp | 20 μM | 163.36 | 1.20 | 5.09 |
| extract- | 50 μM | 154.85 | 1.83 | 10.03 |
| based | 75 μM | 146.05 | 2.18 | 15.15 |
| composition | 100 μM | 132.20 | 0.57 | 23.19 |
| | 150 μM | 120.61 | 1.97 | 29.93 |

Considering the percentage of inhibition obtained for the different concentrations presented in Table 3, the EC20 of γ-mangostin in the phytopharmaceutical composition was found between 75 μM and 100 μM. Any concentration not exceeding 75 μM is therefore considered as non-fungicidal on Z. tritici.

### Study of the Inhibition of Septoria Leaf Blotch of Wheat in Planta (Triad Pathogen—UPR Inhibitor—Plant Defense Molecules)

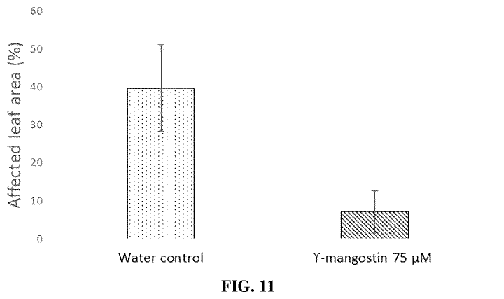

Treatment was made by spraying the mangosteen pericarp extract-based phytopharmaceutical composition at a concentration of γ-mangostin equivalent to 75 μM, or water (control), on leaves of wheat plants at the 2-leaves stage (2 pots of 30 plants per modality). The treatment was applied 24 hours before infection. Inoculation was carried out by spraying a suspension of spores (106 spores/ml) on the leaves, inherently expressing plant defense molecules typically selected from flavonoids, diterpenes, and triterpenes, such as ellarinacin. The treated wheat plants were placed in a climatic chamber during 26 days in suitable temperature conditions (20° C. day/16° C. night, 14 h photoperiod). The intensity of the disease, corresponding to the percentage of the leaf area affected, was then assessed for the two modalities. Results are presented in FIG. 11.

The application of a composition according to the invention, that is a non-fungicidal amount of γ-mangostin against Septoria leaf blotch of wheat (75 μM), induced a significant reduction of the wheat plant leaves' affected area by septoria leaf blotch (7.1% affected area) as opposed to the control leaves (39.8% affected area).

The inventors have showed that a composition according to the invention potentiates the antifungal effect of the plant defense mechanisms of a plant organ infected by a fungal infection. Indeed, the inventors showed that the composition according to the invention exerts a potentiating effect of the antifungal effects of several types of plant defense molecules such as ε-viniferin. This potentiating effect was confirmed in planta in three different plant species, inherently expressing different mechanisms of chemical defense to fungal infections. This potentiating effect was confirmed in planta in three different plant species, inherently expressing different mechanisms of chemical defense to fungal infections and confirmed that the potentiating effect is effective in the prevention, the control and/or the treatment of three different types of phytopathogenic fungi.

1-15. (canceled)

16. A method for preventing, controlling or treating a fungal infection by a phytopathogenic fungal strain on a plant organ, said method comprising the steps of applying on the plant organ a composition comprising at least one UPR (Unfolded Protein Response) inhibitor, in an in vitro sub-effective concentration being a concentration equal or inferior to a non-fungicidal concentration C1 of said inhibitor against the phytopathogenic fungal strain:
wherein the non-fungicidal concentration C1 is determined by comparing the growth of the phytopathogenic fungal strain cultures in contact with increasing concentrations of said at least one UPR inhibitor, with the growth of a control culture of the phytopathogenic fungal strain, in the absence of said at least one UPR inhibitor; the last concentration of the increasing concentrations of the at least one UPR inhibitor resulting in the same fungal culture growth as the control culture being retained as the non-fungicidal concentration C1 of said at least one UPR inhibitor;
wherein the at least one UPR inhibitor is at least one xanthone of formula I: 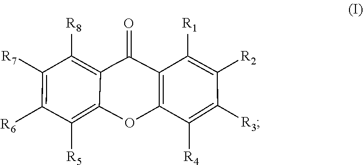
wherein:
R2=R8: prenyl, R1=R3=R6=R7: OH, and R4=R5: H (γ-mangostin);
R1=R3=R5: OH, R2=R6=R7=R8: H, and R4: prenyl (1,3,5 trihydroxy-4-prenylxanthone);
R1=R3=R5: OH, R4=R6=R7=R8: H, and R2: prenyl (1,3,5 trihydroxy-2-prenylxanthone);
R1=R5=R6: OH, R2=R3=R4=R8: H, and R7: prenyl;
R8: geranyl, R1=R3=R6=R7: OH, and R4=R5: H (demethylrubraxanthone); and
R1=R3=R4=R5: OH, R6=R7=R8: H, and R2: prenyl, wherein the R2 and R3 moieties form a 2,3,3-trimethyltetrahydrofuran ring,
wherein the compound of formula (I) inhibits the UPR cellular development and environmental adaptation in the phytopathogenic fungal strain, once they have been exposed to the plant defense molecules expressed by the plant organ.

17. The method according to claim 16, wherein the at least one UPR (Unfolded Protein Response) inhibitor is an IRE-1 (Inositol-Requiring Enzyme 1) inhibitor.

18. The method according to claim 16, wherein the at least one UPR inhibitor is selected from the group consisting of γ-mangostin, 1,3,5 trihydroxy-4-prenylxanthone, 1,3,5 trihydroxy-2-prenylxanthone and a mixture thereof.

19. The method according to claim 16, wherein the at least one UPR inhibitor is γ-mangostin.

20. The method according to claim 16, wherein the at least one UPR inhibitor is comprised in a Garcinia mangostana leaf, bark or pericarp extract.

21. The method according to claim 16, wherein said plant organ is a plant organ of the Brassicacae, Apiaceae, Vitaceae, Rosaceae, Solanaceae, Fabaceae, Poaceae, Musaceae, Alliaceae, Rutaceae and Sterculiaceae families.

22. The method according to claim 16, wherein said plant organ is a plant organ of the plants selected from the group consisting of Brassica oleracea, Daucus carota subsp. Sativus; Vitis vinifera; Malus domestica, Pyrus comunis, Prunus spp., in particular plums, cherries, peaches, nectarines, apricots, and almonds, and Triticum spp.

23. The method according to claim 16, wherein said fungal infection is an infection by at least one phytopathogenic fungus selected from the group consisting of fungi of the order of Erysiphales further selected from the genera Uncinula, Erysiphe, Sphaerotheca; fungi of the order of Dothideales further selected from the genus Venturia);
fungi of the order of Helotiales further selected from the genera Sclerotinia, Monilia/Monilinia, Botrytis/Botryotinia; fungi of the family Pleosporaceae further selected from the genus Alternaria; fungi of the order Mycosphaerellaceae further selected from the families Sclerotinia, Mycosphaerella and Zymoseptoria.

24. The method according to claim 16, wherein said fungal infection is an infection by at least one phytopathogenic fungus selected from the group consisting of the genera Alternaria, Fusarium, Botrytis or Botryotinia, Sclerotinia, Dreschlera, Venturia, Hyaloperonospora, Plasmodiophora, Phoma, Erysiphe, Rhizoctonia, Pythium, Cercospora, Podosphaera, Gymnosporangium, Pythopthora, Plasmopara, Uncinula, Guignardia, Eutypa, Phomopsis, Botryosphaeria, Zymospetoria, Puccinia, Blumeria, Oculimacula, Gaeumannomyces, Pyrenophora, Phakospora, Septoria, Peronospora, Colletotrichum, Microsphaera, Corynespora, Helminthosporium, Pyricularia, Rhizoctonia, Sarocladium, Erythricium, Mycospharella, Urocystis, Monilinia, Taphrina, Cladosporium, Cytospora, Phomopsis, Cercosporidium, Phoma and Leptosphaerulina.

25. The method according to claim 16, wherein the method further comprises applying on the plant organ at least one at least one PKc (Serine/Threonine Protein Kinase C) inhibitor, wherein the at least one at least one PKc inhibitor is applied simultaneously and/or sequentially to the composition comprising at least one UPR (Unfolded Protein Response) inhibitor; wherein the non-fungicidal concentration C2 is determined by comparing the growth of the phytopathogenic fungal strain cultures in contact with increasing concentrations of said at least one PKc inhibitor, with the growth of a control culture of the phytopathogenic fungal strain, in the absence of said at least one PKc inhibitor; the last concentration of the increasing concentrations of the at least one PKc inhibitor resulting in the same fungal culture growth as the control culture being retained as the non-fungicidal concentration C2 of said at least one PKc inhibitor.

26. The method according to claim 25, wherein the said at least one PKc inhibitor is in a sub-effective amount, said sub-effective amount being a concentration equal or inferior to a non-fungicidal concentration C2.

27. The method according to claim 26, wherein the at least one PKc inhibitor is selected from the group consisting of chelerythrin, sanguinarin, berberin, coptisin a mixture thereof, and an extract of Macleaya cordata.

28. The method according to claim 16, wherein the method further comprises applying on the plant organ simultaneously and/or sequentially to the composition comprising at least one UPR inhibitor, at least one agent for stimulating the synthesis of a plant defense molecule; said agent being selected from the group consisting of acibenzolar-S-methyl, chitosan, laminarin, Reynoutria sachalinensis extract, calcium prohexadione, harpine, yeast wall extracts, oligogalacturonides, calcium phosphonate, disodium phosphonate 24-Epibrassinolide, ABE-IT 56 (Yeast Extract), Cerevisane, Chito-oligosaccharides, Oligogalacturonides, Heptamaloxyloglucan, Pepino mosaic virus strain CH2 isolate 1906, Pythium oligandrum strain B301 and a mixture thereof.

29. The method according to claim 16, wherein the composition further comprises at least synthetic or mineral phytopharmaceutical fungistatic or fungicide agent.

30. A phytopharmaceutical composition against a phytopathogenic fungal strain comprising at least one UPR (Unfolded Protein Response) inhibitor in a sub-effective amount, said at least one UPR inhibitor being selected from the group consisting of γ-mangostin, 1,3,5 trihydroxy-4-prenylxanthone, 1,3,5 trihydroxy-2-prenylxanthone and a mixture thereof; said sub-effective amount being a concentration ranging from 5 μM to 500 μM in association with at least one phytopharmaceutical vehicle.

31. The phytopharmaceutical composition according to claim 30, wherein the at least one UPR inhibitor being γ-mangostin.

32. The phytopharmaceutical composition according to claim 30, wherein the sub-effective amount being a concentration ranging from 30 μM to 200 μM.

33. The phytopharmaceutical composition according to claim 30, further comprising at least one PKc inhibitor selected from the group consisting of chelerythrin, sanguinarin, berberin, coptisin and a mixture thereof and/or at least one agent for stimulating the synthesis of a plant defense molecule; said agent being selected from the group consisting of acibenzolar-S-methyl, chitosan, laminarin, Reynoutria sachalinensis extract, calcium prohexadione, harpine, yeast wall extracts, oligogalacturonides, calcium phosphonate, disodium phosphonate and a mixture thereof.

34. A kit-of-parts comprising a first part comprising at least one UPR (Unfolded Protein Response) inhibitor in a sub-effective amount as described in claim 30, and a second part comprising least one phytopharmaceutical vehicle.

35. The kit-of-parts according to claim 34, further comprising a third part comprising at least one PKc inhibitor selected from the group consisting of chelerythrin, sanguinarin, berberin, coptisin and a mixture thereof and/or a fourth part comprising at least one agent for stimulating the synthesis of a plant defense molecule; said agent being selected from the group consisting of acibenzolar-S-methyl, chitosan, laminarin, Reynoutria sachalinensis extract, calcium prohexadione, harpine, yeast wall extracts, oligogalacturonides, calcium phosphonate, disodium phosphonate and a mixture thereof.
